(19) United States
(12) Patent Application Publication
(10) Pub. No.: US 2018/0170795 A1
(43) Pub. Date: Jun. 21, 2018

(54) HIGH-TRANSMISSION GLASS

(71) Applicant: ASAHI GLASS COMPANY, LIMITED, Chiyoda-ku (JP)

(72) Inventors: Takato KAJIHARA, Tokyo (JP); Yusuke ARAI, Tokyo (JP); Naoki KANNO, Tokyo (JP); Takahiro SAKAGAMI, Tokyo (JP)

(73) Assignee: ASAHI GLASS COMPANY, LIMITED, Chiyoda-ku (JP)

(21) Appl. No.: 15/896,322

(22) Filed: Feb. 14, 2018

Related U.S. Application Data
(63) Continuation of application No. PCT/JP2016/073844, filed on Aug. 15, 2016.

(30) Foreign Application Priority Data
Aug. 18, 2015 (JP) 2015-161102
Apr. 1, 2016 (JP) 2016-074513

(51) Int. Cl. C03C 3/091; C03C 3/087; C03C 4/00

(52) U.S. Cl. CPC C03C 3/091; C03C 4/0092; C03C 3/087

(57) ABSTRACT

A glass includes, in mass percentage on an oxide basis, 50 to 85% of SiO₂, 0 to 10% of B₂O₃, 1 to 20% of Na₂O, and 20% or less of K₂O, and Sb₂O₃ is substantially not contained. A total content (Ni+Cr) is more than 0 ppm by mass and 1.2 ppm by mass or less. A total iron oxide (t-Fe₂O₃) in terms of Fe₂O₃, a ratio (Na₂O/Al₂O₃) and a total content (Al₂O₃+K₂O) fall within specific ranges, respectively. The contents of each component satisfy a specific relationship.

### TECHNICAL FIELD

The present invention relates to a high-transmission glass ensuring that the melting performance is excellent, the internal transmittance in the visible region is high, and the internal transmittance spectrum is more flattened, and a glass sheet and a glass article each using the glass.

### BACKGROUND ART

A glass having a high visible light transmittance (so-called white sheet glass, hereinafter, sometimes referred to as “high-transmission glass”) is in demand in various applications. For example, in building application (an interior material, an exterior material), electronic equipment application (a light guide material for planar light-emitting devices, so-called light guide plate), and other industrial applications (e.g., a cover glass for solar power generation modules), there is a method of, for example, using the glass to efficiently transmit visible light and thereby enhance light utilization efficiency or using the glass as a material for providing a high design effect (high grade feeling).

Among others, it was revealed that when a high-transmission glass is adopted in usage for a light guide plate conventionally using an acrylic plate, as the optical path length increases, light absorption inside the glass in the visible region (wavelength: from 380 to 780 nm) cannot be ignored and consequently, the luminance is decreased or in-plane luminance/color unevenness is caused.

A main factor of the light absorption is an iron ion contained as an impurity. The iron ion is in divalent (Fe²⁺) and trivalent (Fe³⁺) states in glass. In particular, the problem is Fe²⁺ having broad absorption at a wavelength of 490 to 780 nm. Fe³⁺ has an absorption band at a wavelength of 380 to 490 nm, but its extinction coefficient per unit concentration is small by one order of magnitude compared to Fe²⁺ and in turn, the effect thereof is small. Accordingly, for reducing light absorption in the visible region, efforts must be undertaken, for example, to reduce the amount of total iron ion in glass or make the ratio of the amount of Fe²⁺ to total iron ion as low as possible.

To meet such a requirement, Patent Document 1 discloses a light guide plate in which the content of Fe₂O₃ in a glass sheet is reduced to 0.1 mass % or less so as to increase the maximum transmittance in the wavelength region of 350 to 750 nm.

In addition, Patent Document 2 discloses a technique of adjusting the matrix composition of soda lime silica glass to reduce the absorption peak intensity near the wavelength of 1,000 to 1,100 nm of divalent iron and increase the solar transmittance Te.

### PRIOR ART DOCUMENTS

### Patent Documents

Patent Document 1: WO 2015/033866 A1

Patent Document 2: WO 2013/161967 A1

### SUMMARY OF THE INVENTION

### Technical Problems

However, studies of the present inventors have revealed that an attempt to make the ratio of the amount of Fe²⁺ in glass small is associated with the following problems (1) and (2).

(1) Reduction in the ratio of the amount of Fe²⁺ leads to an increase of Fe³⁺ contained in glass, giving rise to large light absorption at a wavelength of 380 to 490 nm. In addition, an impurity element (e.g., Ni, Cr) derived from a glass raw material also has light absorption at a wavelength of 380 to 490 nm and therefore, the internal transmittance of glass in the visible region is not flat.

(2) Since Fe²⁺ has absorption in the infrared region, in a glass having a small amount of Fe²⁺, the heat ray absorption is diminished, and the temperature in a glass melt can hardly rise, and as a result, melting performance of the glass during production may deteriorate.

When the internal transmittance of glass is not flat, in the case of, for example, using the glass for a light guide plate of an edge light-type liquid crystal television, colors can be exactly reproduced near a light source because of short light travel distance, but with increasing distance from the light source, colors are subject to a strong effect of absorption by iron or other impurity elements and the colors are slid. In particular, as the screen size of liquid crystal television is larger, a chromaticity difference is readily produced.

In addition, conventional high-transmission glass has a high internal transmittance not only in the visible region but also in the ultraviolet region. Consequently, for example, when the high-transmission glass is used for a solar cell cover, ultraviolet radiation transmitted through the glass may cause deterioration of a member of the solar cell. Accordingly, a glass exhibiting a high internal transmittance in the visible region and a low internal transmittance in the ultraviolet region is demanded.

Furthermore, UV ozone cleaning treatment of irradiating a glass sheet with UV on the short wavelength side is sometimes performed using a low-pressure mercury lamp so as to remove an inorganic substance on the glass surface or modify the surface. UV on the short wavelength side is ultraviolet radiation in a wavelength region called a deep ultraviolet (DUV: Deep UV) region and has a short wavelength compared with UV derived from sunlight. It was found that the transmittance in a specific wavelength region of glass is decreased by irradiation with the DUV.

As a result, the transparency of glass is impaired upon irradiated with DUV and therefore, a glass having high DUV resistance is demanded. The “DUV resistance” as used in the present description is targeted at a change in transmittance between before and after irradiation with short-wavelength UV having a dominant wavelength of 254 nm by use of a low-pressure mercury lamp.

As the glass used for a water sterilization device with an ultraviolet light source such as compact and low-cost ultraviolet LED (ultraviolet light-emitting diode), a curing device for ultraviolet-curable resins, and a device such as ultraviolet sensor, a glass having a high external transmittance in the DUV region is demanded.

Considering these circumstances, an object of the present invention is to provide a glass ensuring that the melting performance is excellent, the internal transmittance in the visible region is high, and the internal transmittance flatness is good, and a glass sheet and a glass article each using the glass. Another object of the present invention is to provide a glass having a low internal transmittance in the ultraviolet region, a glass having high DUV resistance, and a glass having a high external transmittance in the DUV region.

### Solution to Problems

As a result of many intensive studies, the present inventors have found that the above-described objects can be attained by controlling the glass matrix composition. The present invention has been accomplished based on this finding.

That is, the present invention relates to the following <1> to <22>.

<1> A glass comprising from 5 to 90 ppm by mass of a total iron oxide (t-Fe₂O₃) in terms of Fe₂O₃, wherein

contents expressed in mass percentage on an oxide basis are SiO₂: from 50 to 85%, B₂O₃: from 0 to 10%, Na₂O: from 1 to 20%, and K₂O: 20% or less, and Sb₂O₃ is substantially not contained,

a total content (Ni+Cr) of Ni and Cr is more than 0 ppm by mass and 1.2 ppm by mass or less,

a ratio (Na₂O/Al₂O₃) of the content of Na₂O to the content of Al₂O₃, expressed in mass percentage on the oxide basis, is 0.5 or more and 50 or less,

a total content (A1203+K₂O) of Al₂O₃ and K₂O, expressed in mass percentage on the oxide basis, is 1% or more and 20% or less, and

the contents of each component satisfy the following formula (1):

P_{Fe}=[Fe³⁺]×(4.5×[MgO]+3.9×[CaO]+1.7×[SrO]+1.9×[BaO]+2.7×[Al₂O₃]−0.3×[Na₂O]−1.5×[K₂O]−1.7×[Li₂O])≤3000 (1)

wherein [Fe³⁺] represents a content expressed in ppm by mass and the others represent the contents expressed in mass percentage on the oxide basis.

<2> The glass according to <1>, wherein the content of Ni is more than 0 ppm by mass and 0.8 ppm by mass or less.

<3> The glass according to <1> or <2>, wherein the content of Cr is 1.0 ppm by mass or less.

<4> The glass according to any one of <1> to <3>, wherein the content of CeO₂ on the oxide basis is 500 ppm by mass or less.

<5> The glass according to any one of <1> to <4>, wherein the content of Al₂O₃, expressed in mass percentage on the oxide basis, is more than 0% and 14% or less.

<6> The glass according to any one of <1> to <5>, wherein the content of SnO₂, expressed in mass percentage on the oxide basis, is more than 0% and 1% or less.

<7> The glass according to <6>, wherein the content of Al₂O₃, expressed in mass percentage on the oxide basis, is from 10 to 14%.

<8> The glass according to any one of <1> to <7>, comprising from 10 to 65 ppm by mass of the total iron oxide (t-Fe₂O₃) in terms of Fe₂O₃.

<9> The glass according to any one of <1> to <8>, wherein the contents of each component satisfy the following formula (2):

P_{Ni}=[Ni]×(2.2×[MgO]+1.9×[CaO]+1.1×[SrO]+1.1×[BaO])≤21 (2)

wherein [Ni] represents the content expressed in ppm by mass and the others represent the contents expressed in mass percentage on the oxide basis.

<10> The glass according to any one of <1> to <9>, wherein the contents of each component satisfy the following formula (3):

P_{Cr}=[Cr]×(1.9×[MgO]+1.3×[CaO]+0.6×[SrO]+0.5×[BaO])≤21 (3)

wherein [Cr] represents the content expressed in ppm by mass and the others represent the contents expressed in mass percentage on the oxide basis.

<11> The glass according to <10>, wherein a total (P_{Ni}+P_{Cr}) of the P_{Ni} and the P_{Cr} represented by the formulae (2) and (3), respectively, is 25 or less.

<12> The glass according to any one of <1> to <11>, wherein an average value of internal transmittance (a) at a wavelength of 430 to 450 nm at an optical path length of 50 mm is 95.5% or more.

<13> The glass according to any one of <1> to <12>, wherein an amount of divalent iron (Fe²⁺) in terms of Fe₂O₃ is more than 0 ppm by mass and 15 ppm by mass or less.

<14> The glass according to any one of <1> to <13>, wherein contents of alkaline earth metal oxides, expressed in mass percentage, satisfy the relationship of {(CaO+SrO+BaO)—MgO}≥−8.

<15> The glass according to any one of <1> to <14>, wherein a minimum value of internal transmittance (β) at a wavelength of 400 to 700 nm at an optical path length of 50 mm is 94.5% or more and a difference between a maximum value of the internal transmittance (β) and the minimum value of the internal transmittance (β) is 5% or less.

<16> The glass according to any one of <1> to <15>, wherein a value of internal transmittance spectrum flatness A of the glass at a wavelength of 400 to 700 nm, determined according to the following formula (4), is 0.95 or more:

A=min(X,Y,Z)/max(X,Y,Z) (4)

wherein X, Y and Z are values represented respectively by X=E(S(λ)×x(λ)), Y=Σ(S(λ)×y(λ)) and Z=Σ(S(λ)×z(λ)) using isochromatic functions x(λ), y(λ) and z(λ) in an XYZ color system based on JIS Z8701: 1999 and internal transmittance S(λ) at a wavelength of 400 to 700 nm at an optical path length of 200 mm, and the min(X,Y,Z) represents the minimum value out of X, Y and Z and the max(X,Y,Z) represent the maximum value out of X, Y and Z.

<17> The glass according to any one of <1> to <16>, wherein ultraviolet internal transmittance at a wavelength of 260 nm at an optical path length of 1 mm is 70% or less.

<18> The glass according to any one of <1> to <16>, wherein ultraviolet external transmittance at a wavelength of 254 nm at an optical path length of 0.5 mm is 50% or more.

<19> The glass according to any one of <1> to <16> and <18>, wherein ultraviolet external transmittance at a wavelength of 365 nm at an optical path length of 0.5 mm is 80% or more.

<20> A glass sheet comprising the glass according to any one of <1> to <19>.

<21> The glass sheet according to <20>, which has a length of at least one side of 140 mm or more and a thickness of 0.5 mm or more

<22> A light guide plate comprising the glass according to any one of <1> to <19>.

### Advantageous Effects of the Invention

In the present invention, a glass ensuring that the melting performance is excellent, the internal transmittance in the visible region is high, and the internal transmittance flatness is good, and a glass sheet and a glass article each using the glass, can be obtained. Therefore, for example, when the glass of the present invention is used as a light guide plate, even in a large screen, high luminance can be realized and luminance unevenness or color unevenness (chromaticity difference) can be remarkably reduced.

Furthermore, since the glass of the present invention can decrease the internal transmittance in the ultraviolet region, when the glass is used as a glass for solar cell cover, deterioration of a solar cell member by ultraviolet radiation can be prevented. In addition, since the glass of the present invention can realize high DUV resistance, high transparency of glass can be maintained. Moreover, since the glass of the present invention can realize high external transmittance in the DUV region, the glass can be utilized in a device having an ultraviolet light source.

### BRIEF DESCRIPTION OF THE DRAWINGS

FIG. 1 is a graph illustrating the degree of effect of each alkaline earth metal element on the absorption coefficient of Fe′.

FIG. 2 is a graph illustrating the degree of effect of each alkaline earth metal element on the iron redox ratio.

### DESCRIPTION OF EMBODIMENTS

The present invention is described in detail below, but the present invention is not limited to the following embodiment and can be carried out by arbitrarily making modifications therein without departing from the gist of the present invention. In the present description, the expression “to” indicating a numerical range is used in the sense to include the numerical values described before and after the expression as the lower limit and the upper limit.

The glass in the present invention includes from 5 to 90 ppm by mass of a total iron oxide (t-Fe₂O₃) in terms of Fe₂O₃, and contents expressed in mass percentage on an oxide basis are SiO₂: from 50 to 85%, B₂O₃: from 0 to 10%, Na₂O: from 1 to 20%, and K₂O: 20% or less, and Sb₂O₃ is substantially not contained, a total content (Ni+Cr) of Ni and Cr is more than 0 ppm by mass and 1.2 ppm by mass or less, a ratio (Na₂O/Al₂O₃) of the content of Na₂O to the content of Al₂O₃, expressed in mass percentage on the oxide basis, is 0.5 or more and 50 or less, a total content (A1203+K₂O) of Al₂O₃ and K₂O, expressed in mass percentage on the oxide basis, is 1% or more and 20% or less, and the contents of each component satisfy the following formula (1).

P_{Fe}=[Fe³⁺]×(4.5×[MgO]+3.9×[CaO]+1.7×[SrO]+1.9×[BaO]+2.7×[Al₂O₃]−0.3×[Na₂O]−1.5×[K₂O]−1.7×[Li₂O])≤3000 (1)

[In the formula (1), [Fe³⁺] represents a content expressed in ppm by mass and the others represent the contents expressed in mass percentage on the oxide basis.]

Unless otherwise indicated, the composition of the present invention is expressed in mass percentage.

A main factor of the light absorption of glass is an iron ion contained as an impurity. Iron is inevitably contained as a raw material of the industrially produced glass, and mixing of iron in glass is unavoidable. The iron ion is in divalent (Fe²⁺) and trivalent (Fe³⁺) forms in glass. In particular, the problem is associated with Fe²⁺ having broad absorption at a wavelength of 490 to 780 nm.

Fe³⁺ has an absorption band at a wavelength of 380 to 490 nm, but its extinction coefficient per unit concentration is small by one order of magnitude compared to Fe²⁺ and in turn, the effect thereof is small. Accordingly, for reducing light absorption in the visible region, efforts must be undertaken, for example, to make the ratio of the amount of Fe²⁺ to the amount of total iron ion in glass as low as possible, i.e., reduce the redox of iron.

On the other hand, it is known that as the amount of Al₂O₃ in glass is larger, the absorption of Fe²⁺ decreases and the absorption of Fe³⁺ increases. In the case of such a glass, absorption in the visible region can be reduced by increasing the redox.

The method therefor includes, for example, melting at high temperature, and use of a reducing agent such as tin oxide and carbon, but melting at high temperature is disadvantageous in view of increase of fuel cost and burden on kiln. In the case of using tin oxide as the reducing agent, tin oxide has absorption in the visible region and therefore, may decrease the internal transmittance in the visible region. In the case of using carbon, the glass may be colored due to amber coloration caused by reaction with the sulfur content in glass.

In the industrially glass, for reducing the total content of iron contained as an impurity until achieving the same level of internal transmittance of glass as that of acryl, there are many limiting conditions from the aspect of production, raw material, etc. Within an allowable range of the total iron content, in order to increase the internal transmittance of glass to the same level as that of acryl, the redox of iron in low-Al₂O₃ glass must be reduced than ever before.

As described above, in the low-Al₂O₃ glass, the extinction coefficient of Fe³⁺ per unit concentration is small by one order of magnitude compared to Fe²⁺, but when a low redox of Fe is achieved, the proportion of Fe³⁺ increases, and absorption by Fe³⁺ cannot be ignored. In high-Al₂O₃ glass, it is necessary to achieve a high redox as described above, but due to production limitations, the effect of Fe³⁺ having large absorption cannot be ignored.

Above all, in considering adoption of the glass sheet as a light guide plate for an edge light-type planar light emitter such as liquid crystal television, it is important for the glass to provide a flat internal transmittance spectrum in the entire wavelength region at a wavelength of 380 to 780 nm. If the internal transmittance spectrum of glass is not flat, a luminance difference or a chromaticity difference is generated within the screen of a liquid crystal television.

For example, in a light guide plate of a liquid crystal television, colors can be exactly reproduced near a light source because of short light travel distance, but with increasing distance from the light source, colors are subject to a strong effect of absorption by iron or other impurity elements and slid. In particular, as the screen size of liquid crystal television is larger, a luminance difference or a chromaticity difference is likely to be generated.

Accordingly, in the present invention, with respect to iron contained in glass, the content of total iron oxide (t-Fe₂O₃) in terms of Fe₂O₃ is from 5 to 90 ppm by mass and in addition, the content of each component satisfies the following formula (1), whereby absorption by Fe³⁺ in the visible region of glass can be reduced and the internal transmittance at a wavelength of 380 to 490 nm can be increased.

P_{Fe}=[Fe³⁺]×(4.5×[MgO]+3.9×[CaO]+1.7×[SrO]+1.9×[BaO]+2.7×[Al₂O₃]−0.3×[Na₂O]−1.5×[K₂O]−1.7×[Li₂O])≤3000 (1)

[In the formula (1), [Fe³⁺] represents the content expressed in ppm by mass and the others represent the contents expressed in mass percentage on the oxide basis].

The formula (1) shows the relationship between the content of Fe′ in glass and the contents of other alkaline earth metals (MgO, CaO, SrO and BaO), aluminum (Al₂O₃) and alkali metals (Na₂O, K₂O and Li₂O).

In more detail, coefficients 4.5, 3.9, 1.7, 1.9, 2.7, −0.3, −1.5 and −1.7 by which [MgO], [CaO], [SrO], [BaO], [Al₂O₃], [Na₂O], [K₂O] and [Li₂O] of the formula (1) are multiplied mean the degrees of contribution per unit mass % of alkaline earth metal elements, aluminum and alkali metal elements each present in glass to the extinction coefficient of Fe³⁺. When the value of P_{Fe} obtained according to the formula (1) is 3,000 or less, the effect of absorption by Fe³⁺ is small, and a glass having a high internal transmittance at a wavelength of 380 to 490 nm, particularly at a wavelength of 430 to 460 nm, can be obtained.

The value of P_{Fe} represented by the formula (1) is 3,000 or less, preferably 2,000 or less, more preferably 1,500 or less, still more preferably 1,000 or less. In addition, the value of P_{Fe} is preferably 100 or more, more preferably 200 or more.

In order to reduce the cost of glass raw materials and ensure the melting performance of glass as well as to increase the DUV resistance, the content of total iron oxide (t-Fe₂O₃) in terms of Fe₂O₃ is 5 ppm by mass or more, preferably 7 ppm by mass or more, more preferably 10 ppm by mass or more, still more preferably 12 ppm by mass or more. Furthermore, for the reason that it becomes a factor for decreasing the internal transmittance in the visible region and the external transmittance in the DUV region, the content is 90 ppm by mass or less, preferably 75 ppm by mass or less, more preferably 65 ppm by mass or less, still more preferably 55 ppm by mass or less, yet still more preferably 50 ppm by mass or less, even yet still more preferably 45 ppm by mass or less, particularly preferably 40 ppm by mass or less, and most preferably 35 ppm by mass or less, 30 ppm by mass, or 25 ppm by mass.

From the viewpoint of increasing the external transmittance in the DUV region, the content of total iron oxide (t-Fe₂O₃) in terms of Fe₂O₃ is preferably 100 ppm by mass or less, more preferably 65 ppm by mass or less, more preferably 50 ppm by mass or less. When the content of total iron oxide (t-Fe₂O₃) in terms of Fe₂O₃ is 0.5 ppm by mass or more, this is preferable in view of raw material cost, and the content is more preferably 1 ppm by mass or more.

In order to increase the heat ray absorption efficiency of a glass melt during melting of glass raw materials and thereby enhance the melting performance, the amount of divalent iron (Fe²⁺) in terms of Fe₂O₃ is, on the oxide basis, preferably more than 0, more preferably 1 ppm by mass or more. In addition, from the viewpoint of increasing the internal transmittance at a wavelength of 550 to 780 nm and achieving a flat internal transmittance spectrum as well as enhancing the external transmittance in the DUV region, the upper limit is preferably 15 ppm by mass or less, more preferably 10 ppm by mass or less, still more preferably 7 ppm by mass or less, yet still more preferably 5 ppm by mass or less, even yet still more preferably 4 ppm by mass or less, and particularly preferably 3 ppm by mass or less.

In order to reduce the proportion of Fe²⁺ having a large absorption coefficient in the amount of total iron oxide, the amount of trivalent iron (Fe³⁺) in terms of Fe₂O₃ is preferably 5 ppm by mass or more on the oxide basis. In view of decrease of the internal transmittance at a wavelength of 380 to 490 nm and reduction in the spectrum flatness as well as decrease of the external transmittance in the DUV region, the upper limit is preferably 60 ppm by mass or less, more preferably 55 ppm by mass or less, still more preferably 50 ppm by mass or less, yet still more preferably 45 ppm by mass or less, even yet still more preferably 40 ppm by mass or less, particularly preferably 35 ppm by mass or less, and most preferably 30 ppm by mass or less.

As described above, when the ratio of Fe²⁺ is reduced and the absorption coefficient of Fe³⁺ is decreased, high transparency in the visible region of glass is obtained, but on the other hand, due to the presence of an impurity such as Ni and Cr contained in glass raw materials, light absorption at a wavelength of 380 to 780 nm is increased to cause a decrease of the internal transmittance of glass in the visible region, as a result, the internal transmittance spectrum cannot be flat.

Accordingly, a glass with excellent internal transmittance flatness can be obtained by reducing the content of Ni or Cr in glass raw materials. In view of internal transmittance flatness, the total content (Ni+Cr) of Ni and Cr in glass is more than 0 and 1.2 ppm by mass or less.

In order to reduce the cost of glass raw materials, (Ni+Cr) is preferably 0.2 ppm by mass or more. On the other hand, absorption by Ni and Cr works out to one of causes for decreasing the internal transmittance of glass and losing the internal transmittance flatness and therefore, the upper limit is preferably 1.0 ppm by mass or less, more preferably 0.8 ppm by mass or less, still more preferably 0.5 ppm by mass or less.

Ni is preferably contained in glass, because a high internal transmittance of glass can be maintained. This is for the following reason.

A sulfur component intrudes in the process of glass melting or glass molding. The sulfur component binds with Fe in glass to produce iron sulfide which causes coloring and may decrease the internal transmittance. On the other hand, since an Ni component is present in glass, nickel sulfide is selectively formed, and production of the iron sulfide can thereby be prevented, as a result, coloring can be reduced. In addition, as with Fe²⁺, Ni has absorption in the near infrared region at a wavelength of 800 to 1,100 nm and in turn, enhances the heat ray absorption efficiency of a glass melt during glass melting. Accordingly, even when the proportion of Fe²⁺ in glass is small, melting performance of glass can be enhanced.

For this reason, the content of Ni is preferably more than 0, more preferably 0.05 ppm by mass or more, still more preferably 0.1 ppm by mass or more, yet still more preferably 0.12 ppm by mass or more, even yet still more preferably 0.15 ppm by mass or more. On the other hand, Ni has absorption at around wavelengths of 450 nm and 630 nm and works out to one of factors for losing the internal transmittance flatness and for this reason, the content of Ni is preferably 0.8 ppm by mass or less, more preferably 0.6 ppm by mass or less, still more preferably 0.4 ppm by mass or less.

When Ni satisfies the following formula (2), further higher transmittance and higher flatness of the internal transmittance can be achieved.

P_{Ni}=[Ni]×(2.2×[MgO]+1.9×[CaO]+1.1×[SrO]+1.1×[BaO])≤21 (2)

[In the formula (2), [Ni] represents the content expressed in ppm by mass and the others represent the contents expressed in mass percentage on the oxide basis].

The formula (2) shows the relationship between the content of Ni in glass and the contents of other alkaline earth metals (MgO, CaO, SrO and BaO). In more detail, coefficients 2.2, 1.9, 1.1 and 1.1 by which [MgO], [CaO], [SrO] and [BaO] of the formula (2) are multiplied mean the degrees of contribution per unit mass % of alkaline earth metal elements present in glass to the extinction coefficient of Ni. When the value of P_{Ni} obtained according to the formula (2) is 21 or less, the effect of absorption by Ni is small, and a glass having a high internal transmittance at a wavelength of 380 to 490 nm, particularly at a wavelength of 430 to 460 nm, can be obtained.

The value of P_{Ni} represented by the formula (2) is preferably 21 or less, more preferably 15 or less, still more preferably 10 or less, yet still more preferably 5 or less. In addition, the value of P_{Ni} is preferably 0.5 or more, more preferably 1 or more, still more preferably 2 or more.

As with Ni, Cr works out to one of factors for losing the internal transmittance flatness of glass. Accordingly, the content of Cr is preferably 1.0 ppm by mass or less, more preferably 0.5 ppm by mass or less, still more preferably 0.4 ppm by mass or less. On the other hand, Cr may not be contained but is inevitably mixed in from glass raw materials and therefore, may be contained in an amount of 0.1 ppm by mass or more.

When Cr satisfies the following formula (3), further higher transmittance and higher flatness of the internal transmittance can be achieved.

P_{Cr}=[Cr]×(1.9×[MgO]+1.3×[CaO]+0.6×[SrO]+0.5×[BaO])≤21 (3)

[In the formula (3), [Cr] represents the content expressed in ppm by mass and the others represent the contents expressed in mass percentage on the oxide basis].

The formula (3) shows the relationship between the content of Cr in glass and the contents of other alkaline earth metals (MgO, CaO, SrO and BaO). In more detail, coefficients 1.9, 1.3, 0.6 and 0.5 by which [MgO], [CaO], [SrO] and [BaO] of the formula (3) are multiplied mean the degrees of contribution per unit mass % of alkaline earth metal elements present in glass to the extinction coefficient of Cr. When the value of P_{Cr} obtained according to the formula (3) is 21 or less, the effect of absorption by Cr is small, and a glass having a high internal transmittance at a wavelength of 380 to 490 nm, particularly at a wavelength of 430 to 460 nm, can be obtained.

The value of P_{Cr} represented by the formula (3) is preferably 21 or less, more preferably 15 or less, still more preferably 10 or less, yet still more preferably 5 or less. In addition, the value of P_{Cr} is preferably 1 or more, more preferably 2 or more.

In the glass melting step, both Ni and Cr are mixed in from raw materials and therefore, the sum (P_{Ni}+P_{Cr}) of the values of P_{Ni} represented by the formula (2) and P_{Cr} represented by the formula (3) means the degree of effect of Ni and Cr on the absorption. The value of (P_{Ni}+P_{Cr}) is preferably 25 or less, more preferably 24 or less, still more preferably 23 or less, yet still more preferably 21 or less, even yet still more preferably 15 or less, particularly preferably 10 or less. In addition, in view of spectrum flattening, the value is preferably 2 or more.

Glass raw materials are melted at the time of production of a glass, but in a glass where the amount of Fe²⁺ having absorption in the infrared region is small, the heat ray absorption is diminished, and the temperature in a glass melt can hardly rise, as a result, melting performance of the glass during production may deteriorate.

In the glass in the present invention, Na₂O that is a component useful for promoting the melting of glass raw materials and adjusting the thermal expansion, viscous property, etc., is contained in an amount of 1 to 20%, expressed in mass percentage on the oxide basis, and the ratio (Na₂O/Al₂O₃) of the content of Na₂O to the content of Al₂O₃, expressed in mass percentage on the oxide basis, is 0.5 or more and 50 or less, whereby a glass with excellent melting performance can be obtained.

In addition to the viewpoint of melting performance, because of having an effect of reducing the absorption coefficient of Fe, (Na₂O/Al₂O₃) is preferably 0.6 or more, more preferably 1.0 or more, still more preferably 2.0 or more. On the other hand, in view of weather resistance reduction and DUV resistance, the ratio is 50 or less, preferably 40 or less, more preferably 30 or less, still more preferably 20 or less, yet still more preferably 15 or less, even yet still more preferably 12 or less, still more preferably 10 or less, and in view of weather resistance reduction, still more preferably 9.0 or less, yet still more preferably 8.0 or less, most preferably 5.0 or less.

In order to promote the melting of glass raw materials and adjust the thermal expansion, viscous property, etc., the content of Na₂O, expressed in mass percentage on the oxide basis, is 1% or more, preferably 5% or more, still more preferably 7% or more, yet still more preferably 9% or more. On the other hand, in order to keep the fining at the time of melting and maintain the bubble quality of the glass produced as well as to enhance the weather resistance, the content is preferably 18% or less, more preferably 16% or less, still more preferably 13% or less.

Al₂O₃ has an effect of reducing the non-bridging oxygen content in glass and therefore, contributes to enhancing the weather resistance and DUV resistance of the glass. The content of Al₂O₃, expressed in mass percentage on the oxide basis, is preferably more than 0, more preferably 0.1% or more, still more preferably 0.5% or more, yet still more preferably 0.7% or more, and from the viewpoint of enhancing the weather resistance, still more preferably 1% or more, yet still more preferably 1.5% or more, most preferably 2% or more. In addition, from the viewpoint of enhancing the DUV resistance, in the case of containing SnO₂ as described later, the content of Al₂O₃ is still more preferably 10% or more.

On the other hand, if the content of Al₂O₃ is large, this may cause, for example, an increase in the viscous property at the time of melting, an increase in the absorption coefficient of Fe³⁺, a decrease in the internal transmittance in the visible region due to shifting of the fundamental absorption edge in the ultraviolet region to the longer wavelength side, and a decrease in the external transmittance in the DUV region. In addition, most of Al₂O₃ are present in the form of four coordination ([AlO₄]⁻) and combine with an alkali metal ion such as Na⁺.

Accordingly, the amount of an alkali metal ion combined with four coordinated iron ([FeO₄]⁻, i.e., Fe³⁺) is reduced, and the iron ion cannot be present as Fe′, leading to a decrease in the proportion of Fe′. As a result, an increase in the proportion of Fe′, i.e., an increase in the redox, may be caused. For this reason, the content of Al₂O₃ is preferably 14% or less, more preferably 13% or less, still more preferably 10% or less, yet still more preferably 8% or less, even yet still more preferably 5% or less.

In addition to Na₂O described above, K₂O is a component useful for promoting the melting of glass raw materials and adjusting the thermal expansion, viscous property, etc. and is also a component contributing to enhancement of the weather resistance. The content of K₂O, expressed in mass percentage on the oxide basis, is 20% or less, preferably 15% or less, more preferably 10% or less, still more preferably 7% or less, yet still more preferably 5% or less, even yet still more preferably 4% or less, particularly preferably 2% or less. In addition, K₂O may not be contained.

Since Al₂O₃ and K₂O are effective components for enhancing the weather resistance or enhancing the DUV resistance, the total content (Al₂O₃+K₂O) of Al₂O₃ and K₂O, expressed in mass percentage on the oxide basis, is 1% or more, preferably 2% or more, more preferably 2.5% or more, still more preferably 3% or more. On the other hand, in view of increased viscous property and thermal properties at the time of melting, the total content is preferably 20% or less, more preferably 15% or less, still more preferably 14% or less, yet still more preferably 13% or less, even yet still more preferably 10% or less, particularly preferably 8% or less.

When water is present in glass, the heat ray absorption efficiency of a glass melt can be enhanced, because water has absorption in the near infrared region. Water in glass can be generally represented by a value called a β-OH value, and the value is preferably 0.05 or more, more preferably 0.1 or more, still more preferably 0.14 or more. The β-OH value can be obtained according to the following formula from the transmittance of glass measured by means of FT-IR (Fourier transform infrared spectrometer).

β−OH=(1/X)log₁₀(T_{A}/T_{B})[mm⁻¹]

X: the thickness of sample [mm]

T_{A}: the transmittance [%] at a reference wavenumber of 4,000 cm⁻¹

T_{B}: the minimum transmittance [%] at around a hydroxyl group absorption wavenumber of 3,600 cm⁻¹.

As long as the composition of the glass in the present invention has the above-described features, other compositions are not particularly limited. A representative composition as the matrix composition is described below.

Glass matrix composition containing (expressed in mass percentage on the oxide basis): SiO₂: from 50 to 85%, Al₂O₃: more than 0 and 14% or less, MgO: from 0 to 10%, CaO: from 0 to 20%, SrO: from 0 to 20%, BaO: from 0 to 30%, Na₂O: from 1 to 20%, and K₂O: from 0 to 20%.

SiO₂ is a main component of glass and is contained in an amount of 50 to 85%, expressed in mass percentage on the oxide basis. In order to maintain the weather resistance and devitrification properties of glass, the content of SiO₂, expressed in mass percentage on the oxide basis, is preferably 60% or more, more preferably 63% or more.

On the other hand, in order to provide good bubble quality by facilitating melting or realize good optical properties by holding down the content of divalent iron (Fe²⁺) in glass, the content of SiO₂ is preferably 80% or less, more preferably 75% or less.

B₂O₃ is a component capable of promoting the melting of glass raw materials and improving the mechanical properties, weather resistance, internal transmittance in the visible region, and external transmittance in the DUV region, but in order to prevent occurrence of a trouble such as formation of ream and erosion of furnace wall resulting from vaporization due to addition to the glass, the content of B₂O₃, expressed in mass percentage on the oxide basis, is preferably from 0 to 10%, preferably 8% or less, more preferably 6% or less, still more preferably 3% or less. On the other hand, the lower limit is preferably 1% or more from the viewpoint of enhancing the glass properties described above, but the component may be substantially not contained.

In addition to Na₂O and K₂O above, Li₂O is a component useful for promoting the melting of glass raw materials and adjusting the thermal expansion, viscous property, etc. Li₂O is an optional component but can facilitate vitrification and reduce absorption by Fe³⁺. Furthermore, this component holds down the content of iron contained as an impurity and keeps down the batch cost and therefore, Li₂O may be contained in an amount of 2% or less, expressed in mass percentage on the oxide basis.

In order to keep the fining at the time of melting and maintain the bubble quality of the glass produced, the total content (Li₂O+Na₂O+K₂O) of these alkali metal oxides is, on the oxide basis, preferably from 1 to 20%, more preferably from 7 to 15%.

In the glass in the present invention, Sb₂O₃ is substantially not contained, because Sb₂O₃ has a property of being colored in a reducing atmosphere and affecting the internal transmittance in the visible region. The term “substantially not contained” as used in the present description means that the case where the component mixed as an unavoidable impurity is excluded and that the content of the component is below the detection limit when measured by a fluorescent X-ray analysis method.

Alkaline earth metal oxides such as MgO, CaO, SrO and BaO are a component useful for promoting the melting of glass raw materials and adjusting the thermal expansion, viscous property, etc. In addition, these are also a component useful for controlling the absorption by an impurity element such as Fe, Ni or Cr.

In addition to the fact that the contents of those alkaline earth metal oxides satisfy the formulae (1) to (3), respective components of MgO, CaO, SrO and BaO are described below.

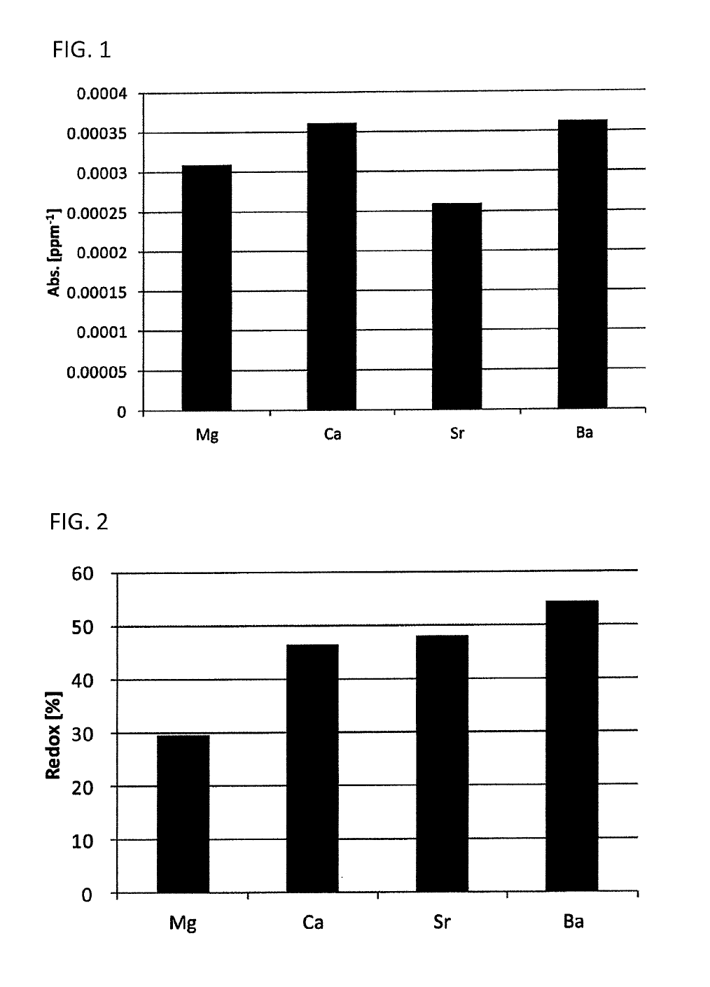

In FIG. 1, with respect to a glass including SiO₂: 74 mol %, Al₂O₃: 1 mol %, Na₂O: 13 mol %, and RO (R=Mg, Ca, Sr, Ba): 12 mol %, the absorption coefficient of Fe′ per 1 ppm by mass at an optical path length of 50 mm is divided by mol % concentration (12 mol %) of the alkaline earth metal in glass. It is understood from the results here that the alkaline earth metal components per unit mol % for reducing the absorption coefficient of Fe³⁺ are suited in the order of Sr>Mg>Ca≈Ba.

The same experiment was performed for alkali metal components and Al₂O₃, and each component per unit mol % was converted to the degree of contribution per unit mass %. The same studies were performed on Ni and Cr. From the degrees of contribution obtained here, the formulae (1), (2) and (3) showing the effect of each component on the absorption by Fe′, Ni and Cr, respectively, were obtained.

FIG. 2 illustrates the relationship between the redox ratio of iron and the alkaline earth metal elements, contained in glass when the melting is performed under the same conditions. It is understood from these results that the redox ratio of iron is increased in the order of Mg, Ca, Sr and Ba, revealing that the redox ratio of iron can be adjusted by the species of the alkaline earth metal.

Redox [%]=[Fe²⁺](ppm by mass)/[t-Fe₂O₃](ppm by mass)×100

MgO has an action of promoting the melting by lowering the viscous property at the time of glass melting and also has an action of reducing the specific gravity to provide a scratch-resistant glass article. In addition, the ion radius of Mg ion is close to the ion radius of Fe²⁺ ion, and the presence of Mg ion leads to occupying Fe²⁺ ion sites, as a result, the proportion of Fe²⁺ can be reduced. Accordingly, MgO contributes to achieving a low redox of iron. Furthermore, for the reason above, a valence change from Fe³⁺ into Fe²⁺ by solarization is less like to occur, and this component is also effective for solarization resistance.

The content of MgO, expressed in mass percentage on the oxide basis, is preferably 1% or more, more preferably 3% or more. On the other hand, since the coefficient of thermal expansion of glass may increase and devitrification properties may deteriorate, in order to reduce the coefficient of thermal expansion of glass and improve the devitrification properties, the content of MgO, expressed in mass percentage on the oxide basis, is preferably 10% or less, more preferably 8% or less.

CaO is a component capable of promoting the melting of glass raw materials and adjusting the viscous property, thermal expansion, etc. and therefore, can be contained. In order to obtain the actions above, the content of CaO, expressed in mass percentage on the oxide basis, is preferably 2% or more, more preferably 4% or more. In addition, in order to improve the devitrification, the content is preferably 10% or less, more preferably 8% or less.

SrO has an effect of suppressing an increase in the coefficient of thermal expansion and lowering the high-temperature viscosity of glass and also has an effect of reducing the absorption coefficient of Fe³⁺ or an effect of shifting the fundamental absorption edge in the ultraviolet region to the visible region. The content of SrO, expressed in mass percentage on the oxide basis, is preferably 1% or more, more preferably 2% or more. However, in order to keep down the coefficient of thermal expansion of glass, the upper limit is preferably 20% or less, more preferably 10% or less, still more preferably 7% or less.

As with SrO, BaO has an effect of suppressing an increase in the coefficient of thermal expansion and lowering the high-temperature viscosity of glass and also has an effect of shifting the fundamental absorption edge in the ultraviolet region to the visible region. In order to obtain these effects, BaO can be contained. The content of BaO, expressed in mass percentage on the oxide basis, is preferably 1% or more, more preferably 2% or more. However, in order to keep down the coefficient of thermal expansion of glass, as the upper limit thereof, it is preferably 30% or less, more preferably 15% or less, still more preferably 7% or less.

In addition to the control of optical properties above, in order to keep down the coefficient of thermal expansion and improve the devitrification properties as well as to maintain the strength, the total content (MgO+CaO+SrO+BaO) of these alkaline earth metal oxides is preferably from 4% to 30%, more preferably from 10% to 25%.

Furthermore, the contents of alkaline earth metal oxides preferably satisfy the relationship of {(CaO+SrO+BaO)−MgO}≥−8.

As described above, Mg present in glass contributes, for example, to reducing the absorption coefficient of Fe³⁺, achieving a low redox of iron, and enhancing the solarization resistance. On the other hand, since Mg leads to an increase of devitrification, the content thereof preferably satisfies the relational expression above. The value represented by the relational expression above is preferably −8 or more, more preferably −4 or more, still more preferably −2 or more, yet still more preferably 0 or more.

The glass of the present invention may contain CeO₂. CeO₂ has an effect of increasing the DUV resistance or an effect of decreasing the redox of iron and can reduce light absorption inside the glass at a wavelength of 400 to 700 nm. In addition, CeO₂ has absorption in the ultraviolet region and therefore, can decrease the internal transmittance in the ultraviolet region.

However, in the case of containing a large amount of CeO₂, since there is concern that CeO₂ not only gives rise to solarization but also functions as a component absorbing visible light, the content thereof is preferably 500 ppm by mass or less relative to the total amount of the glass composition described above. The content of CeO₂ is more preferably 400 ppm by mass or less, more preferably 300 ppm by mass or less, still more preferably 250 ppm by mass or less, most preferably 200 ppm by mass or less. Furthermore, in the case of increasing the external transmittance in the ultraviolet region, particularly in the DUV region, it is preferable that this component is substantially not contained.

In the case of adding this component, 0.1 ppm by mass or more of the component is preferably added always so as to facilitate control of the variation in product properties, particularly the variation in color, at the time of production. For the control of color, addition in an amount of 1.0 ppm by mass or more is preferred, and addition in an amount of 5.0 ppm by mass or more is more preferred.

In the case of expecting an effect of reducing the redox, this component is preferably added in an amount equal to or greater than the amount (ppm by mass) of iron in terms of Fe₂O₃ contained in glass, more preferably in an amount of 1.5 times or more, still more preferably 3 times or more, yet still more preferably 5 times or more, the amount of iron.

The glass in the present invention may contain ZrO₂ as an optional component so as to enhance the heat resistance, surface hardness and DUV resistance of the glass. In this case, the content of ZrO₂, expressed in mass percentage on the oxide basis, is 15% or less, preferably 5% or less. If the content is more than 15%, the glass is disadvantageously apt to be devitrified.

The glass in the present invention may contain SnO₂ as an oxidizing agent and a fining agent. In this case, the content of total Sn in terms of SnO₂, expressed in mass percentage, is preferably from 0% to 1%. From the viewpoint of preventing occurrence of coloring by SnO₂, the content of total Sn in terms of SnO₂ is more preferably 0.5% or less, still more preferably 0.2% or less, yet still more preferably 0.1% or less, and it is more preferred that the component is substantially not contained.

On the other hand, in the case of intending to increase the DUV resistance, SnO₂ is preferably contained in an amount of more than 0 and 1% or less. The content of total Sn in terms of SnO₂ is more preferably 0.001% or more, still more preferably 0.005% or more.

In the case where the glass in the present invention is a glass containing Al₂O₃ in a large amount, particularly, a glass having an Al₂O₃ content of 10 mass % or more expressed in mass percentage on the oxide basis, from the viewpoint of reducing the viscous property of a melt and encouraging the escape of bubbles, fining is preferably performed using SnO₂ as a fining agent. In this case, the content of total Sn in terms of SnO₂ is preferably 1% or less.

From the viewpoint of preventing occurrence of coloring by SnO₂, the content of total Sn in terms of SnO₂ is more preferably 0.5% or less, still more preferably 0.45% or less, yet still more preferably 0.4% or less, even yet still more preferably 0.35% or less, more preferably 0.3% or less, particularly preferably 0.25% or less.

From the viewpoint of enhancing the fining property and DUV resistance, the lower limit of the content of total Sn is preferably more than 0, more preferably 0.001% or more, still more preferably 0.005% or more, yet still more preferably 0.01% or more, even yet still more preferably 0.05% or more, more preferably 0.1% or more, still more preferably 0.15% or more, particularly preferably 0.2% or more.

The fining agent includes SO₃ as well. The content of SO₃, expressed in mass percentage on the oxide basis, is preferably more than 0 and 0.5% or less, more preferably 0.3% or less, still more preferably 0.2% or less, yet still more preferably 0.1% or less.

The oxidizing agent and the fining agent include As₂O₃ as well. As₂O₃ also has an effect of increasing the DUV resistance. In this case, the content of As₂O₃, expressed in mass percentage on the oxide basis, is preferably from 0 to 0.5%, more preferably 0.2% or less, still more preferably 0.1% or less, and since this component should not be positively contained from an environmental standpoint, it is more preferred that the component is substantially not contained.

The glass in the present invention may contain MnO₂. In the case of containing MnO₂, since MnO₂ functions also as a component absorbing visible light, the content of MnO₂ is preferably 5 ppm by mass or less on the oxide basis, relative to the total amount of the glass matrix composition. Above all, from the viewpoint of not decreasing the internal transmittance at a wavelength of 400 to 700 nm, the content of MnO₂ is more preferably 1 ppm by mass or less.

The glass in the present invention may contain TiO₂. TiO₂ has an effect of increasing the DUV resistance, as well. In the case of containing TiO₂, since TiO₂ functions also as a component absorbing visible light, the content of TiO₂ is preferably 1,000 ppm by mass or less on the oxide basis, relative to the total amount of the glass matrix composition. Above all, from the viewpoint of not decreasing the internal transmittance at a wavelength of 400 to 700 nm, the content of TiO₂ is more preferably 100 ppm by mass or less, still more preferably 10 ppm by mass or less. However, in the case of intending to increase the DUV resistance, the content is preferably more than 0.

The glass in the present invention may contain at least one component selected from the group consisting of CoO, V₂O₅ and CuO. In the case of containing such a component, since these components function also as a component absorbing visible light, the total content of at least one component selected from the group consisting of CoO, V₂O₅ and CuO is preferably 10 ppm by mass or less on the oxide basis, more preferably 1 ppm by mass or less, relative to the total amount of the glass matrix composition. Above all, from the viewpoint of not decreasing the internal transmittance at a wavelength of 400 to 700 nm, it is preferred that these components are substantially not contained.

The glass composition of the glass in the present invention can be measured by a fluorescent X-ray method. In addition, boron B that is a light element and can be hardly measured by the fluorescent X-ray method, and trace elements of 1,000 ppm by mass or less can be measured by an ICP emission spectral analysis.

Since the glass in the present invention is a low-iron glass as described above, the temperature of a melt is less likely to rise, and the viscous property of a glass melt assumes importance in view of defoaming (fining) of the melt. When the melting temperature is raised so as to improve fining, the burden on kiln increases. Accordingly, the temperature T2 at which the viscous property of the glass melt corresponds to 10² dPa·s is preferably 1,850° C. or less.

T2 is more preferably 1,800° C. or less, still more preferably 1,750° C. or less, yet still more preferably 1,700° C. or less, even yet still more preferably 1,650° C. or less, more preferably 1,600° C. or less, still more preferably 1,550° C. or less, most preferably 1,500° C. or less.

The melting point of glass can be lowered by adjusting the glass composition, for example, by setting the value of (Na₂O/Al₂O₃) to be 0.5 or more and 50 or less. Here, the viscous property of the glass can be measured by a rotary viscometer.

The glass in the present invention preferably has such high transparency that the average value of the internal transmittance (a) at a wavelength of 430 to 450 nm at the optical path length of 50 mm is 95.5% or more. The average value is more preferably 96% or more, still more preferably 97% or more, yet still more preferably 97.5% or more. The internal transmittance (a) can be achieved by adjusting the glass composition and the amount of impurity such as Fe, Ni or Cr within the above-described range of the composition.

The glass in the present invention preferably has such high transparency that the minimum value of the internal transmittance (β) at a wavelength of 400 to 700 nm at an optical path length of 50 mm is 94.5% or more. The minimum value of the internal transmittance (β) is more preferably 96.0% or more, still more preferably 97.0% or more, yet still more preferably 97.5% or more. The minimum value of the internal transmittance (β) can be achieved by adjusting the glass composition and the amount of impurity such as Fe, Ni or Cr within the above-described range.

The internal transmittance (β) preferably has such flatness that the difference between the maximum value and the minimum value is 5% or less. The difference is more preferably 4% or less, still more preferably 3% or less, yet still more preferably 2% or less. The difference between the maximum value of the internal transmittance (β) and the minimum value of the internal transmittance (β) can be achieved by adjusting the glass composition and the amount of impurity such as Fe, Ni or Cr within the above-described range.

The flatness of the internal transmittance at a wavelength of 400 to 700 nm of the glass in the present invention can be evaluated as the value of the internal transmittance spectrum flatness A according to the following formula (4):

A=min(X,Y,Z)/max(X,Y,Z) (4)

[In the formula (4), X, Y and Z are values represented respectively by X=Σ(S(λ)×x(λ)), Y=Σ(S(λ)×y(λ)) and Z=Σ(S(λ)×z(λ)) using isochromatic functions x(λ), y(λ) and z(λ) in the XYZ color system based on JIS Z8701: 1999 and internal transmittance S(λ) at a wavelength of 400 to 700 nm at an optical path length of 200 mm, and min(X,Y,Z) represent the minimum value out of X, Y and Z, and max(X,Y,Z) represent the maximum value out of X, Y and Z].

The internal transmittance S(λ) is acquired at intervals of 1 nm.

X in the XYZ color system based on JIS Z8701: 1999 is a stimulus value of red in the human eye, Y is a stimulus value of green in the human eye, and Z is a stimulus value of blue in the human eye.

When the value of the internal transmittance spectrum flatness A of the glass at a wavelength of 400 to 700 nm obtained by the formula (4) is large, this means that the above-described stimulus values of three colors are close to each other. In the case of using such a glass as a light guide plate, color unevenness is perceived as small unevenness by the human eye.

More specifically, the value of flatness A represented by the formula (4) is preferably larger and is preferably 0.95 or more, more preferably 0.96 or more, still more preferably 0.97 or more. The upper limit of flatness A is 1. The value of flatness A can be achieved by adjusting the glass composition and the impurity amount within the above-described range.

The ultraviolet internal transmittance S(λ) at an optical path length of 200 mm in the formula (4) can be experimentally obtained as follows.

A cuboid (hereinafter, sometimes referred to as a glass cuboid) in which the long side is 50.0 mm, the other side is in an arbitrary length shorter than 50.0 mm, and the thickness is 1.8 mm, is prepared, and all surfaces thereof are mirror-polished. Light is transmitted in the long-side direction of the prepared glass cuboid, and the external transmittance T(λ) is measured by means of a spectrophotometer. The spectrophotometer is used by combining, for example, Spectrophotometer UH4150 manufactured by Hitachi High-Technologies Corporation with a detector of the same company capable of measuring a long sample. The transmittance T(λ) at 50.0 mm is acquired at intervals of 1 nm in the wavelength range of 400 to 700 nm.

Subsequently, the refractive index of the glass cuboid at each wavelength of at least g-line (435.8 nm), F-line (486.1 nm), e-line (546.1 nm), d-line (587.6 nm), and C-line (656.3 nm) is measured by a V-block method using, for example, Accurate Refractometer KPR-2000 manufactured by Shimadzu Corporation, and respective coefficients B₁, B₂, B₃, C₁, C₂, and C₃ of Sellmeier dispersion equation [the following formula (I)] are determined by a least-squares method based on the measured values. The refractive index n(λ) of the glass is thereby obtained.

n(λ)=[1+{B₁λ²/(λ²−C₁)}+{B₂λ²/(λ²−C₂)}+{B₃λ²/(λ²−C₃)}]^{0.5} (I)

Based on the refractive index n(λ) obtained by the formula (I), the reflectance R(λ) on one surface of the glass cuboid is determined according to the relational expression of refractive index and reflectance [the following formula (II)].

R(λ)=(n(λ)−1)²/(n(λ)+1)² (II)

The external transmittance T(λ) is a measured value affected by the surface reflection of the glass cuboid and therefore, the internal transmittance U(λ) is obtained by removing the influence of the surface reflection. The internal transmittance U(λ) at an optical path length of 50 mm of the glass article is obtained according to the following formula (III). The obtained internal transmittance U(λ) at an optical path length of 50 mm can be converted to the internal transmittance S(λ) at an optical path length of 200 mm according to the following formula (IV).

U(λ)=−[(1−R(λ))²+{(1−R(λ))⁴+4R(λ)²T(λ)²}^{0.5}]/2R(λ)²T(λ) (III)

S(λ)=U(λ)⁴ (IV)

In the glass in the present invention, the ultraviolet internal transmittance at a wavelength of 260 nm at an optical path length of 1 mm is preferably lower. When the ultraviolet internal transmittance is low, in the case of using the glass in the present invention for a glass article exposed to ultraviolet light, such as solar cell cover, there is advantageously no concern that ultraviolet radiation transmitted through the glass causes deterioration of a solar cell, etc. covered with the glass. Also from the viewpoint of enhancing the DUV resistance, the ultraviolet internal transmittance is preferably low. The ultraviolet internal transmittance is preferably 70% or less, more preferably 60% or less, still more preferably 50% or less.

In the case of using the glass in the present invention for a glass article used in an apparatus equipped with an ultraviolet light source, the glass is required to efficiently transmit ultraviolet radiation, particularly DUV, to a certain extent and therefore, the ultraviolet external transmittance at a wavelength of 254 nm at an optical path length of 0.5 mm is preferably 50% or more, more preferably 60% or more, still more preferably 70% or more, yet still more preferably 80% or more.

Furthermore, in the glass, the ultraviolet external transmittance at a wavelength of 365 nm at an optical path length of 0.5 mm may be 80% or more. When an ultraviolet transmitting glass having such optical properties is applied to an apparatus utilizing ultraviolet light having a wavelength of 365 nm, the apparatus can be efficiently operated. The external transmittance at a wavelength of 365 nm is preferably 82% or more, more preferably 85% or more, still more preferably 90% or more.

The ultraviolet internal transmittance and ultraviolet external transmittance can be achieved by adjusting the glass composition and the impurity amount within the above-described range.

The glass in the present invention is preferably in the form of a glass sheet or a glass article. The glass sheet has various sizes according to use. For example, in the case of using the glass sheet for a light guide plate of an edge light-type liquid crystal television, the length of at least one side of the glass sheet is preferably 200 mm or more. The thickness of the glass sheet is preferably 0.5 mm or more, more preferably 1.5 mm or more, still more preferably 2.0 mm or more.

In the case of using the glass sheet for a light guide plate of an in-vehicle liquid crystal display device, the length of at least one side of the glass sheet is preferably 140 mm or more. The thickness of the glass sheet is preferably 1.0 mm or more, more preferably 1.5 mm or more, still more preferably 2.0 mm or more, and is preferably 10 mm or less.

In this way, the preferable size or thickness varies depending on use, but it is generally preferred that the length of at least one side is 140 mm or more and the thickness is 0.5 mm or more.

The glass sheet in the present invention can be manufactured by a normal method. More specifically, the glass sheet can be obtained by melting glass raw materials blended such that the composition of the glass produced becomes a desired composition, by a conventional method to obtain a molten glass, and molding the molten glass by use of a molding method such as float method, roll out method, drawing method, cold top method or fusion method.

The glass article in the present invention includes, for example, a liquid crystal television, a display, a light guide plate for in-vehicle liquid crystal display devices, a cover for solar cells, and a back sheet for solar cells. Among others, since the internal transmittance in the visible region is high and the flatness of internal transmittance is excellent, the glass is more preferably used as a liquid crystal television, a display and a light guide plate for in-vehicle liquid crystal display devices. In addition, since the internal transmittance in the visible region is high and the internal transmittance in the ultraviolet region can be decreased at least to 70% or less, the glass is more preferably used for solar cell application.

Furthermore, since the DUV resistance is excellent, the transparency of the glass is not impaired by UV ozone cleaning treatment, etc., and the glass is more preferably used for applications such as a liquid crystal television, a display, a light guide plate for in-vehicle liquid crystal devices, a cover for solar cells, and a back sheet for solar cells.

From the viewpoint of efficiently transmitting DUV to a certain extent, the suitable usage includes, for example, an article utilizing a low-pressure mercury lamp, a high-pressure mercury lamp, an ultraviolet LED (ultraviolet light-emitting diode), etc. Specifically, the usage includes a water sterilization device, a curing device for ultraviolet-curable resins, an ultraviolet sensor, etc.

From the viewpoint of enhancing the strength, the glass in the present invention may be subjected to strengthening treatment. The strengthening method includes an air cooling strengthening treatment, a chemical strengthening treatment, etc.

### EXAMPLES

The present invention is specifically described below by referring to Examples, but the present invention is not limited thereto. The cases 1, 2, 15, 47 and 48 are Comparative Examples, and the others are Examples.

### <Melting of Glass>

Raw materials of respective components were mixed to afford a target composition and melted at a temperature of 1,500 to 1,700° C. for 3 to 10 hours by using a platinum crucible. At the melting, 400 g of the raw materials were charged in three portions at intervals of 20 minutes and stirred for 1 hour by inserting a platinum stirrer into the molten glass to homogenize the glass. Subsequently, the molten glass was allowed to flow out, molded into a sheet shape, and slowly cooled to room temperature at a cooling rate of 1° C. per minute to obtain a glass block. The particle size of the raw material and the kind and amount of the fining agent may be appropriately selected.

For example, the particle size of the raw material is from 1 to 1,000 μm, the kind of the raw material includes silica sand, aluminum oxide, sodium carbonate, etc., the kind of the fining agent includes sulfate, tin oxide, nitrate, etc., and the amount of the fining agent is from 0.1 to 0.5 mass %.

The content of each component shown in the Table is a content expressed in mass percentage on the oxide basis at a depth of 5,000 nm or more from the glass substrate surface.

### <Evaluation>

### (Glass Composition)

With respect to the obtained glass block, the glass composition excluding boron B and elements of 1,000 ppm by mass or less was determined by subjecting the glass block after polishing to identification by a fluorescent X-ray method using ZSX100e manufactured by Rigaku Corporation. The measurement conditions are described below.

Polishing Conditions:

Part of the obtained glass block was cut, and the measurement surface was polished to remove 5 μm or more by means of a grindstone of #1000.

Measurement Conditions:

Tube voltage: 50 kV, measurement diameter: 30 mmϕ

The method for measuring the content of B in the glass is described below. An aqueous sodium hydroxide solution was added to a pulverized glass and heated to cause decomposition, and nitric acid was then added to the decomposed solution to form an acidic solution. Ion-exchanged water was added to the acidic solution to make a given amount, and the concentration of B was measured by ICP emission spectral analysis.

The concentration was then calculated from a calibration curve prepared using a standard solution. From the measured concentration and the decomposed amount of glass, the content of B in the glass was calculated. The measurement was performed using SPS3100 manufactured by Hitachi High-Tech Science Corporation as the ICP emission spectrophotometer.

(Amount of t-Fe₂O₃, Amount of Fe²⁺, Amount of Fe³⁺)

The amount of a total iron oxide (t-Fe₂O₃) was measured as follows. A mixed acid of hydrofluoric acid and perchloric acid was added to a pulverized glass and heated to cause decomposition. After the decomposition, hydrochloric acid was added to make a given amount, and the concentration of Fe was measured by ICP emission spectral analysis.

The concentration was then calculated from a calibration curve prepared using a standard solution. From the measured concentration and the decomposed amount of glass, the content of t-Fe₂O₃ in the glass was calculated. The measurement was performed using SPS3100 manufactured by Hitachi High-Tech Science Corporation as the ICP emission spectrophotometer.

The method for measuring the content of Fe²⁺ is described below. After decomposing a pulverized glass with a mixed acid of hydrofluoric acid and hydrochloric acid at room temperature, a given amount portion of the decomposed solution was separated and collected in a plastic vessel, and a 2,2′-dipyridyl solution and an ammonium acetate buffer solution were quickly added thereto to color-develop only Fe²⁺. The color-developed solution was treated with ion-exchanged water to make a given amount, and the absorbance at a wavelength of 522 nm was measured by an absorptiometer.

The concentration was then calculated from a calibration curve prepared using a standard solution. From the measured concentration and the decomposed amount of glass, the content (ppm by mass) of Fe²⁺ in the glass, in terms of Fe₂O₃, was calculated. Here, UV-1700 manufactured by Shimadzu Corporation was used as the absorptiometer.

The content (ppm by mass) of Fe³⁺ was, as represented by the following formula, determined from a difference between the amount of total iron oxide and the content of Fe²⁺ and indicated in terms of Fe₂O₃.

Fe³⁺=(t−Fe₂O₃)−(Fe²⁺)

### (Amounts of Ni and Cr)

A mixed acid of hydrofluoric acid and perchloric acid was added to a pulverized glass and heated to cause decomposition. After the decomposition, nitric acid was added to make a given amount, and the concentrations of Ni and Cr were measured by ICP emission spectral analysis. The concentrations were then calculated from a calibration curve prepared using a standard solution. From the measured concentration and the decomposed amount of glass, the content of each of Ni and Cr in the glass was calculated. Here, Agilent 8800 manufactured by Agilent Technologies was used as the ICP mass spectrometer.

### (Internal Transmittance in Visible Region)

The internal transmittance at a wavelength of 400 to 700 nm of the obtained glass block was measured using Spectrophotometer UH4150 manufactured by Hitachi High-Technologies Corporation. Measurement conditions are described below.

The glass block was processed into a glass cuboid in which the long side is 50.0 mm, the other side, i.e., the short side is 30.0 mm, and the thickness is 1.8 mm, and all surfaces were mirror-polished. Light was transmitted in the long-side direction of the prepared glass cuboid, and the external transmittance T(λ) was measured by means of a spectrophotometer. At this time, the spectrophotometer was used by combining it with a detector of the same company capable of measuring a long sample. The external transmittance T(λ) at an optical path length of 50.0 mm was acquired at intervals of 1 nm in the wavelength range of 400 to 700 nm.

Subsequently, the refractive index of the glass cuboid at each wavelength of at least g-line (435.8 nm), F-line (486.1 nm), e-line (546.1 nm), d-line (587.6 nm), and C-line (656.3 nm) was measured by a V-block method using Accurate Refractometer KPR-2000 manufactured by Shimadzu Corporation, and respective coefficients B₁, B₂, B₃, C₁, C₂, and C₃ of Sellmeier dispersion equation [the following formula (I)] were determined by a least-squares method based on the measured values. The refractive index n(λ) of the glass was thereby obtained.

n(λ)=[1+{B₁λ²/(λ²−C₁)}+{B₂λ²/(λ²−C₂)}+{B₃λ²/(λ²−C₃)}]^{0.5} (I)

Based on the refractive index n(λ) obtained by the formula (I), the reflectance R(λ) on one surface of the glass cuboid was determined according to the relational expression of refractive index and reflectance [the following formula (II)].

R(λ)=(n(λ)−1)²/(n(λ)+1)² (II)

The external transmittance T(λ) is a measured value affected by the surface reflection of the glass cuboid and therefore, the influence of the surface reflection must be removed so as to obtain the internal transmittance U(λ). Accordingly, the internal transmittance U(λ) at a length of 50.0 mm of the glass article was obtained according to the following formula (III). As the internal transmittance S(λ) at an optical path length of 200 mm, a value as converted using the following formula (IV) was used.

U(λ)=−[(1−R(λ))²+{(1−R(λ))⁴+4R(λ)²T(λ)²}^{0.5}]/2R(λ)²T(λ) (III)

S(λ)=U(λ)⁴ (IV)

### (Ultraviolet Internal Transmittance)

The glass block was processed into 3 cm×3 cm and a thickness of 1 mm, and the surfaces in the thickness direction were mirror-polished. Light was transmitted in the thickness direction of the prepared glass, and the external transmittance T(λ) was measured by means of a spectrophotometer. Spectrophotometer U4100 manufactured by Hitachi High-Technologies Corporation was used as the spectrophotometer. The transmittance T(λ) at a thickness of 1 mm (an optical path length of 1 mm) was acquired at intervals of 1 nm in the wavelength range of 250 to 400 nm.

The influence of the surface reflection was removed from the reflectance R obtained by the method above, and the internal transmittance U(λ) at a wavelength of 260 nm (ultraviolet internal transmittance) at an optical path length of 1 mm of the glass article was obtained according to the formula (III).

(Ultraviolet External Transmittance) The glass block was processed into 3 cm×3 cm and a thickness of 0.5 mm, and the surfaces in the thickness direction were mirror-polished. Light was transmitted in the thickness direction of the prepared glass, and the external transmittance T(λ) was measured by means of a spectrophotometer. Spectrophotometer U4100 manufactured by Hitachi High-Technologies Corporation was used as the spectrophotometer. The transmittance T(λ) at a thickness of 0.5 mm (an optical path length of 0.5 mm) was acquired at intervals of 1 nm in the wavelength range of 250 to 400 nm.

### (Melting Performance: Viscous Property)

The temperature (T2) at which the viscosity becomes 10² dPa·s was measured using a rotary viscometer.

### Test Example 1

Glass raw materials were blended to afford a composition shown in Table 1 and melted as described above to obtain a glass block. Thereafter, processing into a glass sheet suited for each measurement was performed. The composition of the glass obtained (matrix composition, composition parameters, impurity elements, added elements), the values (parameters) represented by the formulae (1) to (3), optical properties, and viscous property (temperature (T2) at which the viscosity becomes 10² dPa·s, manufacturing properties) are shown in Table 1. Sb₂O₃ was not contained in the glass.

The formulae (1) to (3) are shown below.

P_{Fe}=[Fe³⁺]×(4.5×[MgO]+3.9×[CaO]+1.7×[SrO]+1.9×[BaO]+2.7×[Al₂O₃]−0.3×[Na₂O]−1.5×[K₂O]−1.7×[Li₂O])≤3000 (1)

[In the formula (1), [Fe³⁺] represents the content expressed in ppm by mass and the others represent the contents expressed in mass percentage on the oxide basis].

P_{Ni}=[Ni]×(2.2×[MgO]+1.9×[CaO]+1.1×[SrO]+1.1×[BaO])≤21 (2)

[In the formula (2), [Ni] represents the content expressed in ppm by mass and the others represent the contents expressed in mass percentage on the oxide basis].

P_{Cr}=[Cr]×(1.9×[MgO]+1.3×[CaO]+0.6×[SrO]+0.5×[BaO])≤21 (3)

[In the formula (3), [Cr] represents the content expressed in ppm by mass and the others represent the contents expressed in mass percentage on the oxide basis].

As for optical properties, the average value of the internal transmittance (α) at a wavelength of 430 to 450 nm at an optical path length of 50 mm, the average value (internal transmittance S(λ)) of the internal transmittance (β) at a wavelength of 400 to 700 nm at an optical path length of 200 mm, and the maximum value, minimum value and difference therebetween of the internal transmittance (β) at a wavelength of 400 to 700 nm at an optical path length of 50 mm are shown.

The values of parameters X, Y and Z in the following formula (4) calculated using the internal transmittance S(λ) and the value of internal transmittance spectrum flatness A are also shown. Furthermore, the ultraviolet internal transmittance at a wavelength of 260 nm at an optical path length of 1 mm and the ultraviolet external transmittance at a wavelength of 365 nm and a wavelength of 254 nm at an optical path length of 0.5 mm are also shown.

A=min(X,Y,Z)/max(X,Y,Z) (4)

[In the formula (4), X, Y and Z are values represented respectively by X=Σ(S(λ)×x(λ)), Y=Σ(S(λ)×y(λ)) and Z=Σ(S(λ)×z(λ)) using isochromatic functions x(λ), y(λ) and z(λ) in the XYZ color system based on JIS Z8701: 1999 and internal transmittance S(λ) at a wavelength of 400 to 700 nm at an optical path length of 200 mm, and min(X,Y,Z) represent the minimum value out of X, Y and Z, and max(X,Y,Z) represent the maximum value out of X, Y and Z].

### Test Examples 2 to 62

Glass sheets were obtained in the same manner except that the glass composition in Test Example 1 was changed to respective compositions shown in Tables 1 to 5. The composition and each of the physical properties of the glass obtained are shown in Tables 1 to 5. In all glasses, Sb₂O₃ was not contained.

The items in Tables 1 to 5 are as follows.

“P_{Fe}”, “P_{Ni}” and “P_{Cr}”: The values represented by the formulae (1), (2) and (3).

“Ave. Internal T@430-450 nm [%]”: The average value of the internal transmittance (a) at a wavelength of 430 to 450 nm at an optical path length of 50 mm.

“Max Internal T [%]”: The maximum value of the internal transmittance (β) at a wavelength of 400 to 700 nm at an optical path length of 50 mm.

“Min Internal T [%]”: The minimum value of the internal transmittance (β) at a wavelength of 400 to 700 nm at an optical path length of 50 mm.

“ΔInternal T (Max−Min) [%]”: The difference between the maximum value and the minimum value of the internal transmittance (β) at a wavelength of 400 to 700 nm at an optical path length of 50 mm.

“X”, “Y”, “Z” and “Spectrum Flatness A”: The parameters X, Y and Z in the formula (4) and the value A determined according to the formula (4).

“Internal T@260 nm-1 mm”: The ultraviolet internal transmittance at a wavelength of 260 nm at an optical path wavelength of 1 mm.

“External T@254 nm-0.5 mm”: The ultraviolet external transmittance at a wavelength of 254 nm at an optical path wavelength of 0.5 mm.

External T@365 nm-0.5 mm”: The ultraviolet external transmittance at a wavelength of 365 nm at an optical path wavelength of 0.5 mm.

“T2 [° C.]”: The temperature (T2) at which the viscosity becomes 10² dPa·s.

In the Tables, “−” means unmeasured data, and the parenthesized value means a calculated value. The calculated value of T2 can be determined by establishing a regression equation from the measurement results of the viscous property of various glasses measured by means of a rotary viscometer and calculating the temperature using the equation.

TABLE 1

| | | Case | | | | | | | | | | | | | | |
|---|---|---|---|---|---|---|---|---|---|---|---|---|---|---|---|---|
| Test Example | | 1 | 2 | 3 | 4 | 5 | 6 | 7 | 8 | 9 | 10 | 11 | 12 | 13 | 14 | 15 |
| Ma- | SiO₂ | 61.8 | 73.1 | 67.4 | 77.4 | 74.9 | 75.0 | 61.8 | 67.3 | 68.7 | 66.8 | 68.0 | 67.0 | 60.8 | 76.2 | 59.9 |
| trix | Al₂O₃ | 1.4 | 5.2 | 1.5 | 1.8 | 1.7 | 1.7 | 1.4 | 4.2 | 5.0 | 5.6 | 5.9 | 6.9 | 12.4 | 1.7 | 17.3 |
| com- | B₂O₃ | 0.0 | 0.0 | 0.0 | 0.0 | 0.0 | 0.0 | 0.0 | 0.0 | 0.0 | 0.0 | 0.0 | 0.0 | 0.0 | 0.0 | 8.0 |
| po- | MgO | 0.0 | 8.2 | 0.0 | 8.4 | 8.2 | 0.0 | 0.0 | 8.8 | 4.1 | 7.3 | 9.0 | 8.0 | 0.0 | 8.3 | 3.2 |
| sition | CaO | 0.0 | 0.0 | 0.0 | 0.0 | 0.0 | 11.3 | 0.0 | 3.2 | 7.3 | 1.0 | 1.0 | 2.0 | 2.0 | 0.0 | 4.0 |
| [wt | SrO | 0.0 | 0.0 | 18.8 | 0.0 | 0.0 | 0.0 | 0.0 | 0.0 | 0.0 | 0.0 | 0.0 | 0.0 | 1.8 | 0.0 | 7.6 |
| %] | BaO | 25.6 | 0.0 | 0.0 | 0.0 | 0.0 | 0.0 | 25.6 | 0.0 | 0.0 | 0.0 | 0.0 | 0.0 | 8.0 | 0.0 | 0.0 |
| | Na₂O | 11.2 | 13.6 | 12.2 | 10.8 | 10.4 | 10.5 | 11.2 | 15.2 | 14.6 | 16.6 | 16.1 | 16.1 | 15.0 | 13.8 | 0.0 |
| | K₂O | 0.0 | 0.0 | 0.0 | 0.0 | 4.8 | 0.0 | 0.0 | 1.3 | 0.2 | 0.0 | 0.0 | 0.0 | 0.0 | 0.0 | 0.0 |
| | Li₂O | 0.0 | 0.0 | 0.0 | 1.6 | 0.0 | 1.5 | 0.0 | 0.0 | 0.0 | 0.0 | 0.0 | 0.0 | 0.0 | 0.0 | 0.0 |
| | ZrO₂ | 0.0 | 0.0 | 0.0 | 0.0 | 0.0 | 0.0 | 0.0 | 0.0 | 0.0 | 2.7 | 0.0 | 0.0 | 0.0 | 0.0 | 0.0 |
| Com- | Al₂O₃ + | 1.4 | 5.2 | 1.5 | 1.8 | 6.5 | 1.7 | 1.4 | 5.5 | 5.2 | 5.6 | 5.9 | 6.9 | 12.4 | 1.7 | 17.3 |
| posi- | K₂O | | | | | | | | | | | | | | | |
| tional | Na₂O/ | 7.9 | 2.6 | 7.9 | 6.1 | 6.1 | 6.1 | 7.9 | 3.6 | 2.9 | 3.0 | 2.7 | 2.3 | 1.2 | 7.9 | 0.0 |
| pa- | Al₂O₃ | | | | | | | | | | | | | | | |
| ram- | (CaO + | 25.6 | −8.2 | 18.8 | −8.4 | −8.2 | 11.3 | 25.6 | −5.6 | 3.2 | −6.3 | −8.0 | −6.0 | 11.8 | −8.3 | 8.4 |
| eter | SrO + | | | | | | | | | | | | | | | |
| | BaO)— | | | | | | | | | | | | | | | |
| | MgO | | | | | | | | | | | | | | | |
| Impu- | Total Fe | 130 | 105 | 90 | 90 | 90 | 90 | 88 | 75 | 75 | 75 | 75 | 75 | 75 | 65 | 42 |
| rity | as Fe₂O₃ | | | | | | | | | | | | | | | |
| ele- | Fe³⁺ | 67.1 | 65.1 | 46.5 | 49.3 | 57.4 | 36.4 | 40.1 | — | — | — | — | — | — | 45.7 | 22.5 |
| ment | Fe²⁺ | 62.9 | 39.9 | 43.5 | 40.7 | 32.6 | 53.6 | 47.9 | — | — | — | — | — | — | 19.3 | 24.2 |
| [ppm] | Ni | 0.31 | 0.36 | 0.34 | 0.39 | 0.37 | 0.37 | 0.31 | — | — | — | — | — | — | 0.38 | 0.12 |
| | Cr | 0.31 | 0.36 | 0.34 | 0.39 | 0.37 | 0.37 | 0.31 | — | — | — | — | — | — | 0.38 | 0.1 |
| | Ni + Cr | 0.62 | 0.72 | 0.68 | 0.78 | 0.74 | 0.74 | 0.62 | — | — | — | — | — | — | 0.76 | 0.22 |
| Added | CeO₂ | 0 | 0 | 0 | 0 | 0 | 0 | 0 | — | — | — | — | — | — | 0 | 0 |
| ele- | [ppm] | | | | | | | | | | | | | | | |
| ment | | | | | | | | | | | | | | | | |
| Pa- | P_{Fe} | 3293 | 3033 | 1514 | 1814 | 1781 | 1573 | 1967 | — | — | — | — | — | — | 1732 | 2017 |
| ram- | P_{Ni} | 8.7 | 6.5 | 7.0 | 7.2 | 6.6 | 8.0 | 8.7 | — | — | — | — | — | — | 6.9 | 2.8 |
| eter | P_{Cr} | 4.0 | 5.6 | 3.8 | 6.2 | 5.7 | 5.5 | 4.0 | — | — | — | — | — | — | 6.0 | 1.6 |
| | P_{Ni} + P_{Cr} | 12.7 | 12.1 | 10.9 | 13.5 | 12.4 | 13.4 | 12.7 | — | — | — | — | — | — | 12.9 | 4.3 |
| Op- | Ave. | 93.9 | 92.1 | 96.7 | 95.6 | 96.3 | 96.7 | 95.6 | — | — | — | — | — | — | 96.2 | 96.7 |
| tical | Internal | | | | | | | | | | | | | | | |
| prop- | T @ | | | | | | | | | | | | | | | |
| erties | 430-450 | | | | | | | | | | | | | | | |
| @ | nm [%] | | | | | | | | | | | | | | | |
| 50 | Max | 96.3 | 95.5 | 98.0 | 97.6 | 98.0 | 98.1 | 97.3 | — | — | — | — | — | — | 98.0 | 99.4 |
| mm | Internal | | | | | | | | | | | | | | | |
| (400- | T [%] | | | | | | | | | | | | | | | |
| 700 | Min | 77.2 | 82.5 | 84.1 | 87.7 | 87.2 | 83.4 | 83.1 | — | — | — | — | — | — | 90.8 | 90.9 |
| nm) | Internal | | | | | | | | | | | | | | | |
| | T [%] | | | | | | | | | | | | | | | |
| | ΔInternal | 19.1 | 13.0 | 13.9 | 9.9 | 10.8 | 14.7 | 14.2 | — | — | — | — | — | — | 7.2 | 8.5 |
| | T | | | | | | | | | | | | | | | |
| | (Max-Min) | | | | | | | | | | | | | | | |
| | [%] | | | | | | | | | | | | | | | |
| Op- | X | 75.9 | 77.2 | 84.9 | 87.3 | 87.8 | 85.1 | 83.5 | — | — | — | — | — | — | 91.4 | 101.6 |
| tical | Y | 82.8 | 82.6 | 90.3 | 91.7 | 92.4 | 90.7 | 88.9 | — | — | — | — | — | — | 94.9 | 102.7 |
| prop- | Z | 84.8 | 79.5 | 94.3 | 90.9 | 93.3 | 95.1 | 90.5 | — | — | — | — | — | — | 92.7 | 94.6 |
| erties | Spectrum | 0.895 | 0.934 | 0.900 | 0.951 | 0.941 | 0.895 | 0.922 | — | — | — | — | — | — | 0.963 | 0.921 |
| @ 200 | flatness A | | | | | | | | | | | | | | | |
| mm | | | | | | | | | | | | | | | | |
| (400- | | | | | | | | | | | | | | | | |
| 700 | | | | | | | | | | | | | | | | |
| nm) | | | | | | | | | | | | | | | | |
| Op- | Internal T | — | — | 23.6 | 21.8 | — | — | 24.0 | — | — | — | — | — | — | — | — |
| tical | @ 260 | | | | | | | | | | | | | | | |
| prop- | nm-1 mm | | | | | | | | | | | | | | | |
| erties | | | | | | | | | | | | | | | | |
| @ 1 | | | | | | | | | | | | | | | | |
| mm | | | | | | | | | | | | | | | | |
| Op- | External | — | — | 38.7 | 37.3 | — | — | 39.3 | — | — | — | — | — | — | — | — |
| tical | T | | | | | | | | | | | | | | | |
| prop- | @ 254 | | | | | | | | | | | | | | | |
| erties | nm-0.5 | | | | | | | | | | | | | | | |
| @ | mm | | | | | | | | | | | | | | | |
| 0.5 | External | — | — | 91.4 | 91.9 | — | — | 90.9 | — | — | — | — | — | — | — | — |
| mm | T | | | | | | | | | | | | | | | |
| | @ 365 | | | | | | | | | | | | | | | |
| | nm-0.5 | | | | | | | | | | | | | | | |
| | mm | | | | | | | | | | | | | | | |
| Manu- | T2 [° C.] | — | — | — | — | — | — | — | — | — | — | — | — | — | — | 1670 |
| fac- | | | | | | | | | | | | | | | | |
| turing | | | | | | | | | | | | | | | | |
| prop- | | | | | | | | | | | | | | | | |
| erties | | | | | | | | | | | | | | | | |

TABLE 2

| | | Case | | | | | | | | | | | | |
|---|---|---|---|---|---|---|---|---|---|---|---|---|---|---|
| Test Example | | 16 | 17 | 18 | 19 | 20 | 21 | 22 | 23 | 24 | 25 | 26 | 27 | 28 |
| Matrix | SiO₂ | 69.7 | 70.6 | 69.9 | 68.9 | 76.2 | 73.8 | 70.3 | 70.7 | 71.4 | 69.9 | 69.9 | 67.3 | 68.7 |
| com- | Al₂O₃ | 3.0 | 3.0 | 5.3 | 3.0 | 1.7 | 1.7 | 3.0 | 3.0 | 1.5 | 3.0 | 3.0 | 4.2 | 5.0 |
| position | B₂O₃ | 2.0 | 0.0 | 0.0 | 0.0 | 0.0 | 0.0 | 0.0 | 0.0 | 0.0 | 0.0 | 0.0 | 0.0 | 0.0 |
| [w %] | MgO | 0.0 | 0.0 | 0.0 | 0.0 | 8.3 | 0.0 | 1.3 | 2.9 | 8.0 | 8.0 | 4.0 | 8.8 | 4.1 |
| | CaO | 8.0 | 8.1 | 8.0 | 6.2 | 0.0 | 11.2 | 6.3 | 4.1 | 0.0 | 0.0 | 4.0 | 3.2 | 7.3 |
| | SrO | 4.0 | 4.1 | 1.6 | 7.2 | 0.0 | 0.0 | 4.0 | 4.1 | 4.0 | 4.0 | 4.0 | 0.0 | 0.0 |
| | BaO | 2.0 | 4.1 | 4.0 | 4.0 | 0.0 | 0.0 | 4.0 | 4.1 | 4.0 | 4.0 | 4.0 | 0.0 | 0.0 |
| | Na₂O | 11.0 | 9.2 | 11.0 | 10.9 | 13.8 | 13.4 | 11.1 | 11.2 | 11.0 | 11.0 | 11.0 | 15.2 | 14.6 |
| | K₂O | 0.0 | 0.0 | 0.0 | 0.0 | 0.0 | 0.0 | 0.0 | 0.0 | 0.0 | 0.0 | 0.0 | 1.3 | 0.2 |
| | Li₂O | 0.0 | 1.0 | 0.0 | 0.0 | 0.0 | 0.0 | 0.0 | 0.0 | 0.0 | 0.0 | 0.0 | 0.0 | 0.0 |
| | ZrO₂ | 0.0 | 0.0 | 0.0 | 0.0 | 0.0 | 0.0 | 0.0 | 0.0 | 0.0 | 0.0 | 0.0 | 0.0 | 0.0 |
| Com- | Al₂O₃ + K₂O | 3.0 | 3.0 | 5.3 | 3.0 | 1.7 | 1.7 | 3.0 | 3.0 | 1.5 | 3.0 | 3.0 | 5.5 | 5.2 |
| positional | Na₂O/Al₂O₃ | 3.7 | 3.0 | 2.1 | 3.7 | 7.9 | 7.9 | 3.7 | 3.7 | 7.3 | 3.7 | 3.7 | 3.6 | 2.9 |
| parameter | (CaO + SrO + | 14.0 | 16.2 | 13.7 | 17.3 | −8.3 | 11.2 | 13.1 | 9.3 | 0.0 | 0.0 | 8.0 | −5.6 | 3.2 |
| | BaO)—MgO | | | | | | | | | | | | | |
| Impurity | Total Fe | 38 | 38 | 38 | 36 | 35 | 35 | 34 | 34 | 34 | 33 | 31 | 30 | 30 |
| element | as Fe₂O₃ | | | | | | | | | | | | | |
| [ppm] | Fe³⁺ | 21.8 | 19.4 | 15.5 | 21.2 | 25.1 | 20.1 | 16.8 | 19.7 | 32.3 | 30.7 | 27.9 | — | — |
| | Fe²⁺ | 16.2 | 18.6 | 22.5 | 14.8 | 9.9 | 14.9 | 17.3 | 14.3 | 1.7 | 2.3 | 3.1 | — | — |
| | Ni | 0.13 | 0.14 | 0.13 | 0.12 | 0.38 | 0.37 | 0.14 | 0.14 | 0.37 | 0.35 | 0.35 | — | — |
| | Cr | 0.1 | 0.11 | 0.1 | 0.1 | 0.38 | 0.37 | 0.12 | 0.12 | 0.37 | 0.35 | 0.35 | — | — |
| | Ni + Cr | 0.23 | 0.25 | 0.23 | 0.22 | 0.76 | 0.74 | 0.26 | 0.26 | 0.74 | 0.7 | 0.7 | — | — |
| Added | CeO₂ [ppm] | 0 | 0 | 0 | 0 | 250 | 250 | 0 | 0 | 200 | 200 | 200 | — | — |
| element | | | | | | | | | | | | | | |
| Parameter | P_{Fe} | 1016 | 972 | 819 | 1029 | 950 | 886 | 831 | 954 | 1657 | 1699 | 1478 | — | — |
| | P_{Ni} | 2.8 | 3.4 | 2.8 | 2.9 | 6.9 | 7.8 | 3.3 | 3.2 | 9.8 | 9.3 | 8.8 | — | — |
| | P_{Cr} | 1.4 | 1.7 | 1.3 | 1.4 | 6.0 | 5.4 | 1.8 | 1.8 | 7.3 | 6.9 | 6.0 | — | — |
| | P_{Ni} + P_{Cr} | 4.2 | 5.1 | 4.1 | 4.3 | 12.9 | 13.2 | 5.1 | 5.1 | 17.1 | 16.1 | 14.9 | — | — |
| Optical | Ave. Internal T | 96.5 | 97.7 | 96.1 | 96.5 | 97.5 | 97.8 | 97.3 | 97.2 | 97.7 | 97.7 | 97.6 | — | — |
| properties | @ 430-450 nm | | | | | | | | | | | | | |
| @ 50 mm | [%] | | | | | | | | | | | | | |
| (400-700 | Max Internal | 98.2 | 98.9 | 98.0 | 98.0 | 98.8 | 98.8 | 98.5 | 98.6 | 99.3 | 99.3 | 99.3 | — | — |
| nm) | T [%] | | | | | | | | | | | | | |
| | Min Internal | 90.2 | 93.6 | 92.7 | 94.7 | 96.0 | 94.3 | 94.4 | 95.2 | 97.7 | 97.7 | 97.5 | — | — |
| | T [%] | | | | | | | | | | | | | |
| | ΔInternal T | 7.9 | 5.3 | 5.3 | 3.3 | 2.9 | 4.5 | 4.2 | 3.4 | 1.6 | 1.7 | 1.8 | — | — |
| | (Max-Min) [%] | | | | | | | | | | | | | |
| Optical | X | 91.2 | 96.5 | 93.0 | 94.9 | 104.3 | 104.1 | 95.0 | 95.6 | 101.8 | 101.9 | 101.9 | — | — |
| properties | Y | 94.9 | 99.2 | 95.9 | 96.7 | 105.0 | 104.9 | 97.4 | 97.8 | 102.8 | 103.0 | 103.0 | — | — |
| @ 200 mm | Z | 94.6 | 98.0 | 92.1 | 93.4 | 104.0 | 104.2 | 95.1 | 94.8 | 98.1 | 98.2 | 97.9 | — | — |
| (400-700 | Spectrum | 0.961 | 0.973 | 0.961 | 0.966 | 0.975 | 0.976 | 0.976 | 0.970 | 0.954 | 0.953 | 0.950 | — | — |
| nm) | flatness A | | | | | | | | | | | | | |
| Optical | Internal T | — | — | — | — | 47.8 | 59.7 | — | — | — | — | — | — | — |
| properties | @ 260 | | | | | | | | | | | | | |
| @ 1 mm | nm-1 mm | | | | | | | | | | | | | |
| Optical | External T @ | — | — | — | — | 59.9 | 67.5 | — | — | — | — | — | — | — |
| properties | 254 nm-0.5 mm | | | | | | | | | | | | | |
| @ 0.5 mm | External T @ | — | — | — | — | 91.7 | 91.2 | — | — | — | — | — | — | — |
| | 365 nm-0.5 mm | | | | | | | | | | | | | |
| Manu- | T2 [° C] | 1483 | 1489 | 1541 | 1430 | — | — | 1475 | 1491 | 1474 | 1484 | 1473 | — | — |
| facturing | | | | | | | | | | | | | | |
| properties | | | | | | | | | | | | | | |

TABLE 3

| | | Case | | | | | | | | | | | | |
|---|---|---|---|---|---|---|---|---|---|---|---|---|---|---|
| Test Example | | 29 | 30 | 31 | 32 | 33 | 34 | 35 | 36 | 37 | 38 | 39 | 40 | 41 |
| Matrix | SiO₂ | 66.8 | 68.0 | 67.0 | 60.8 | 70.6 | 69.2 | 71.4 | 70.0 | 69.2 | 70.0 | 70.0 | 70.0 | 70.0 |
| composition | Al₂O₃ | 5.6 | 5.9 | 6.9 | 12.4 | 3.0 | 3.0 | 1.5 | 3.0 | 3.0 | 3.0 | 3.0 | 3.0 | 3.0 |
| [wt %] | B₂O₃ | 0.0 | 0.0 | 0.0 | 0.0 | 0.0 | 0.0 | 0.0 | 0.0 | 0.0 | 0.0 | 0.0 | 0.0 | 0.0 |
| | MgO | 7.3 | 9.0 | 8.0 | 0.0 | 0.0 | 0.0 | 4.0 | 0.0 | 0.0 | 0.0 | 0.0 | 0.0 | 0.0 |
| | CaO | 1.0 | 1.0 | 2.0 | 2.0 | 8.1 | 7.9 | 4.0 | 8.0 | 7.9 | 8.0 | 8.0 | 8.0 | 8.0 |
| | SrO | 0.0 | 0.0 | 0.0 | 1.8 | 4.1 | 4.0 | 4.0 | 4.0 | 4.0 | 4.0 | 4.0 | 4.0 | 4.0 |
| | BaO | 0.0 | 0.0 | 0.0 | 8.0 | 4.1 | 4.0 | 4.0 | 4.0 | 4.0 | 4.0 | 4.0 | 4.0 | 4.0 |
| | Na₂O | 16.6 | 16.1 | 16.1 | 15.0 | 9.2 | 9.0 | 11.0 | 11.0 | 9.0 | 11.0 | 11.0 | 11.0 | 11.0 |
| | K₂O | 0.0 | 0.0 | 0.0 | 0.0 | 0.0 | 2.9 | 0.0 | 0.0 | 2.9 | 0.0 | 0.0 | 0.0 | 0.0 |
| | Li₂O | 0.0 | 0.0 | 0.0 | 0.0 | 1.0 | 0.0 | 0.0 | 0.0 | 0.0 | 0.0 | 0.0 | 0.0 | 0.0 |
| | ZrO₂ | 2.7 | 0.0 | 0.0 | 0.0 | 0.0 | 0.0 | 0.0 | 0.0 | 0.0 | 0.0 | 0.0 | 0.0 | 0.0 |
| Compositional | Al₂O₃ + K₂O | 5.6 | 5.9 | 6.9 | 12.4 | 3.0 | 5.9 | 1.5 | 3.0 | 5.9 | 3.0 | 3.0 | 3.0 | 3.0 |
| parameter | Na₂O/Al₂O₃ | 3.0 | 2.7 | 2.3 | 1.2 | 3.0 | 3.0 | 7.3 | 3.7 | 3.0 | 3.7 | 3.7 | 3.7 | 3.7 |
| | (CaO + SrO + | −6.3 | −8.0 | −6.0 | 11.8 | 16.2 | 15.9 | 8.0 | 16.0 | 15.9 | 16.0 | 16.0 | 16.0 | 16.0 |
| | BaO)—MgO | | | | | | | | | | | | | |
| Impurity | Total Fe | 30 | 30 | 30 | 30 | 29 | 29 | 28 | 26 | 26 | 25 | 25 | 25 | 25 |
| element [ppm] | as Fe₂O₃ | | | | | | | | | | | | | |
| | Fe³⁺ | — | — | — | — | 26.9 | 16.8 | 26.0 | 25.8 | 24.1 | 23.2 | 23.2 | 23.2 | 23.2 |
| | Fe²⁺ | — | — | — | — | 2.1 | 12.2 | 2.0 | 0.2 | 1.9 | 1.8 | 1.8 | 1.8 | 1.8 |
| | Ni | — | — | — | — | 0.14 | 0.13 | 0.37 | 0.35 | 0.13 | 0.2 | 0.2 | 0.16 | 0.16 |
| | Cr | — | — | — | — | 0.11 | 0.1 | 0.37 | 0.35 | 0.1 | 0.25 | 0.35 | 0.25 | 0.35 |
| | Ni + Cr | — | — | — | — | 0.25 | 0.23 | 0.74 | 0.7 | 0.23 | 0.45 | 0.55 | 0.41 | 0.51 |
| Added element | CeO₂ [ppm] | — | — | — | — | 250 | 0 | 200 | 250 | 250 | 200 | 200 | 200 | 200 |
| Parameter | P_{Fe} | — | — | — | — | 1347 | 776 | 1273 | 1300 | 1114 | 1169 | 1169 | 1169 | 1169 |
| | P_{Ni} | — | — | — | — | 3.4 | 3.1 | 9.4 | 8.4 | 3.1 | 4.8 | 4.8 | 3.8 | 3.8 |
| | P_{Cr} | — | — | — | — | 1.7 | 1.5 | 6.4 | 5.2 | 1.5 | 3.7 | 5.2 | 3.7 | 5.2 |
| | P_{Ni} + P_{Cr} | — | — | — | — | 5.1 | 4.6 | 15.7 | 13.6 | 4.6 | 8.5 | 10.0 | 7.5 | 9.0 |
| Optical | Ave. Internal T | — | — | — | — | 97.7 | 97.2 | 97.5 | 98.2 | 96.8 | 98.9 | 98.8 | 98.9 | 98.8 |
| properties @ | @ 430-450 nm | | | | | | | | | | | | | |
| 50 mm | [%] | | | | | | | | | | | | | |
| (400-700 nm) | Max Internal | — | — | — | — | 99.1 | 98.5 | 99.3 | 99.8 | 98.9 | 99.6 | 99.6 | 99.7 | 99.7 |
| | T [%] | | | | | | | | | | | | | |
| | Min Internal | — | — | — | — | 97.6 | 95.0 | 97.5 | 97.5 | 96.7 | 98.8 | 98.8 | 98.8 | 98.8 |
| | T [%] | | | | | | | | | | | | | |
| | ΔInternal T | — | — | — | — | 1.5 | 3.5 | 1.8 | 2.3 | 2.2 | 0.8 | 0.9 | 0.9 | 0.9 |
| | (Max-Min) [%] | | | | | | | | | | | | | |
| Optical | X | — | — | — | — | 101.4 | 96.6 | 101.9 | 105.8 | 99.9 | 104.1 | 103.9 | 104.3 | 104.1 |
| properties @ | Y | — | — | — | — | 102.2 | 98.5 | 103.1 | 106.1 | 100.9 | 104.9 | 104.7 | 105.1 | 104.9 |
| 200 mm | Z | — | — | — | — | 98.1 | 95.8 | 97.7 | 104.7 | 94.7 | 102.4 | 102.1 | 102.7 | 102.3 |
| (400-700 nm) | Spectrum | — | — | — | — | 0.960 | 0.972 | 0.948 | 0.959 | 0.939 | 0.976 | 0.975 | 0.977 | 0.975 |
| | flatness A | | | | | | | | | | | | | |
| Optical | Internal T @ | — | — | — | — | — | — | — | 43.5 | — | 51.0 | — | — | — |
| properties | 260 nm-1 mm | | | | | | | | | | | | | |
| @ 1 mm | | | | | | | | | | | | | | |
| Optical | External T @ | — | — | — | — | — | — | — | 53.8 | — | 59.1 | — | — | — |
| properties @ | 254 nm-0.5 mm | | | | | | | | | | | | | |
| 0.5 mm | External T @ 365 | — | — | — | — | — | — | — | 91.0 | — | 91.1 | — | — | — |
| | nm-0.5 mm | | | | | | | | | | | | | |
| Manufacturing | T2 [° C.] | — | — | — | — | 1489 | 1470 | 1463 | 1465 | 1470 | 1465 | 1465 | 1465 | 1465 |
| properties | | | | | | | | | | | | | | |

TABLE 4

| | | Case | | | | | | | | | | | |
|---|---|---|---|---|---|---|---|---|---|---|---|---|---|
| Test Example | | 42 | 43 | 44 | 45 | 46 | 47 | 48 | 49 | 50 | 51 | 52 | 53 |
| Matrix | SiO₂ | 69.0 | 71.4 | 69.9 | 71.4 | 69.0 | 76.2 | 76.2 | 71.4 | 69.0 | 71.4 | 69.0 | 69.0 |
| composition | Al₂O₃ | 10.0 | 1.5 | 3.0 | 1.5 | 5.0 | 1.7 | 1.7 | 1.5 | 13.0 | 1.5 | 8.0 | 3.0 |
| [wt %] | B₂O₃ | 8.0 | 0.0 | 0.0 | 0.0 | 8.0 | 0.0 | 0.0 | 0.0 | 5.0 | 0.0 | 5.0 | 0.0 |
| | MgO | 4.0 | 5.0 | 4.0 | 8.0 | 4.0 | 8.3 | 8.3 | 5.0 | 2.0 | 6.0 | 6.0 | 0.0 |
| | CaO | 0.0 | 2.0 | 4.0 | 0.0 | 4.0 | 0.0 | 0.0 | 2.0 | 2.0 | 1.0 | 0.0 | 9.0 |
| | SrO | 2.0 | 3.0 | 4.0 | 4.0 | 4.0 | 0.0 | 0.0 | 4.0 | 2.0 | 6.0 | 4.0 | 4.0 |
| | BaO | 2.0 | 6.0 | 4.0 | 4.0 | 1.0 | 0.0 | 0.0 | 5.0 | 1.0 | 3.0 | 0.0 | 4.0 |
| | Na₂O | 5.0 | 11.0 | 11.0 | 11.0 | 5.0 | 13.8 | 13.8 | 11.0 | 6.0 | 11.0 | 8.0 | 11.0 |
| | K₂O | 0.0 | 0.0 | 0.0 | 0.0 | 0.0 | 0.0 | 0.0 | 0.0 | 0.0 | 0.0 | 0.0 | 0.0 |
| | Li₂O | 0.0 | 0.0 | 0.0 | 0.0 | 0.0 | 0.0 | 0.0 | 0.0 | 0.0 | 0.0 | 0.0 | 0.0 |
| | ZrO₂ | 0.0 | 0.0 | 0.0 | 0.0 | 0.0 | 0.0 | 0.0 | 0.0 | 0.0 | 0.0 | 0.0 | 0.0 |
| Compositional | Al₂O₃ + K₂O | 10.0 | 1.5 | 3.0 | 1.5 | 5.0 | 1.7 | 1.7 | 1.5 | 13.0 | 1.5 | 8.0 | 3.0 |
| parameter | Na₂O/Al₂O₃ | 0.5 | 7.3 | 3.7 | 7.3 | 1.0 | 7.9 | 7.9 | 7.3 | 0.5 | 7.3 | 1.0 | 3.7 |
| | (CaO + SrO + | 0.0 | 6.0 | 8.0 | 0.0 | 5.0 | −8.3 | −8.3 | 6.0 | 3.0 | 4.0 | −2.0 | 17.0 |
| | BaO)—MgO | | | | | | | | | | | | |
| Impurity | Total Fe as Fe₂O₃ | 25 | 20 | 20 | 20 | 20 | 16 | 15 | 15 | 15 | 10 | 10 | 6 |
| element [ppm] | Fe³⁺ | 14.3 | — | — | 18.9 | 13.0 | 10.2 | 10.5 | — | 8.3 | — | 7.0 | 5.4 |
| | Fe²⁺ | 10.8 | — | — | 1.1 | 7.0 | 4.8 | 4.5 | — | 6.8 | — | 3.0 | 0.6 |
| | Ni | 0.18 | — | — | 0.15 | 0.18 | 0.38 | 1 | — | 0.18 | — | 0.18 | 0.14 |
| | Cr | 0.35 | — | — | 0.2 | 0.35 | 1.3 | 0.38 | — | 0.35 | — | 0.35 | 0.19 |
| | Ni + Cr | 0.53 | — | — | 0.35 | 0.53 | 1.68 | 1.38 | — | 0.53 | — | 0.53 | 0.33 |
| Added element | CeO₂ [ppm] | 0 | — | — | 200 | 0 | 0 | 0 | — | 0 | — | 0 | 250 |
| Parameter | P_{Fe} | 722 | — | — | 970 | 706 | 386 | 398 | — | 457 | — | 371 | 293 |
| | P_{Ni} | 2.4 | — | — | 3.9 | 3.9 | 6.9 | 18.2 | — | 2.0 | — | 3.1 | 3.6 |
| | P_{Cr} | 3.4 | — | — | 3.9 | 5.5 | 20.5 | 6.0 | — | 2.8 | — | 4.8 | 3.1 |
| | P_{Ni} + P_{Cr} | 5.8 | — | — | 7.8 | 9.4 | 27.4 | 24.2 | — | 4.9 | — | 7.9 | 6.6 |
| Optical | Ave. Internal T @ | — | — | — | 98.9 | — | 95.5 | 95.9 | — | — | — | — | — |
| properties @ | 430-450 nm [%] | | | | | | | | | | | | |
| 50 mm | Max Internal T [%] | — | — | — | 99.7 | — | 98.4 | 98.4 | — | — | — | — | — |
| (400-700 nm) | Min Internal T [%] | — | — | — | 98.9 | — | 95.4 | 95.7 | — | — | — | — | — |
| | ΔInternal T | — | — | — | 0.9 | — | 3.0 | 2.7 | — | — | — | — | — |
| | (Max-Min) [%] | | | | | | | | | | | | |
| Optical properties | X | — | — | — | 104.5 | — | 96.0 | 96.9 | — | — | — | — | — |
| @ 200 mm | Y | — | — | — | 105.2 | — | 97.9 | 97.5 | — | — | — | — | — |
| (400-700 nm) | Z | — | — | — | 102.5 | — | 89.7 | 91.0 | — | — | — | — | — |
| | Spectrum flatness A | — | — | — | 0.974 | — | 0.916 | 0.933 | — | — | — | — | — |
| Optical properties | Internal T @ 260 | — | — | — | — | — | — | — | — | — | — | — | — |
| @ 1 mm | nm-1 mm | | | | | | | | | | | | |
| Optical | External T @ 254 | — | — | — | — | — | — | — | — | — | — | — | — |
| properties | nm-0.5 mm | | | | | | | | | | | | |
| @ 0.5 mm | External T @ 365 | — | — | — | — | — | — | — | — | — | — | — | — |
| | nm-0.5 mm | | | | | | | | | | | | |
| Manufacturing | T2 [° C.] | (1787) | — | — | 1474 | — | — | — | 1474 | (1832) | 1457 | (1656) | 1465 |
| properties | | | | | | | | | | | | | |

TABLE 5

| | | Case | | | | | | | | | | | |
|---|---|---|---|---|---|---|---|---|---|---|---|---|---|
| Test Example | | 54 | 55 | 56 | 57 | 58 | 59 | 60 | 61 | 62 | 63 | 64 | 65 |
| Matrix | SiO₂ | 76.0 | 76.0 | 67.0 | 67.0 | 67.5 | 67.0 | 66.5 | 67.5 | 66.0 | 70.0 | 70.0 | 67.4 |
| com- | Al₂O₃ | 0.2 | 0.2 | 0.5 | 0.5 | 10.0 | 11.0 | 12.0 | 13.0 | 14.0 | 3.0 | 3.0 | 1.5 |
| position | B₂O₃ | 0.0 | 0.0 | 0.0 | 0.0 | 10.0 | 9.0 | 8.0 | 7.7 | 6.0 | 0.0 | 0.0 | 0.0 |
| [wt %] | MgO | 3.0 | 3.0 | 4.0 | 4.0 | 1.2 | 1.5 | 1.8 | 0.8 | 2.5 | 0.0 | 0.0 | 0.0 |
| | CaO | 10.0 | 10.0 | 8.0 | 8.0 | 0.0 | 0.0 | 0.0 | 0.0 | 0.0 | 8.0 | 8.0 | 0.0 |
| | SrO | 0.0 | 0.0 | 0.0 | 0.0 | 3.7 | 2.5 | 3.5 | 4.0 | 3.0 | 4.0 | 4.0 | 18.8 |
| | BaO | 0.0 | 0.0 | 0.0 | 0.0 | 0.0 | 0.0 | 0.0 | 0.0 | 0.0 | 4.0 | 4.0 | 0.0 |
| | Na₂O | 10.0 | 10.0 | 1.0 | 1.0 | 7.6 | 9.0 | 8.2 | 7.0 | 8.5 | 11.0 | 11.0 | 12.2 |
| | K₂O | 0.8 | 0.8 | 19.5 | 19.5 | 0.0 | 0.0 | 0.0 | 0.0 | 0.0 | 0.0 | 0.0 | 0.0 |
| | Li₂O | 0.0 | 0.0 | 0.0 | 0.0 | 0.0 | 0.0 | 0.0 | 0.0 | 0.0 | 0.0 | 0.0 | 0.0 |
| | ZrO₂ | 0.0 | 0.0 | 0.0 | 0.0 | 0.0 | 0.0 | 0.0 | 0.0 | 0.0 | 0.0 | 0.0 | 0.0 |
| Com- | Al₂O₃ + K₂O | 1.0 | 1.0 | 20.0 | 20.0 | 10.0 | 11.0 | 12.0 | 13.0 | 14.0 | 3.0 | 3.0 | 1.5 |
| positional | Na₂O/Al₂O₃ | 50.0 | 50.0 | 2.0 | 2.0 | 0.8 | 0.8 | 0.7 | 0.5 | 0.6 | 3.7 | 3.7 | 7.9 |
| parameter | (CaO + SrO + | 7.0 | 7.0 | 4.0 | 4.0 | 2.5 | 1.0 | 1.7 | 3.2 | 0.5 | 16.0 | 16.0 | 18.8 |
| | BaO)—MgO | | | | | | | | | | | | |
| Impurity | Total Fe as Fe₂O₃ | 60 | 60 | 50 | 50 | 18 | 8 | 15 | 10 | 13 | 12 | 16 | 35 |
| element | Fe³⁺ | 45.5 | 57.5 | 35.0 | 42.7 | 9.5 | 4.6 | 7.8 | 5.7 | 7.3 | 10.3 | 13.7 | 20.6 |
| [ppm] | Fe²⁺ | 14.5 | 2.5 | 15.0 | 7.3 | 8.5 | 3.4 | 7.2 | 4.3 | 5.7 | 1.7 | 2.3 | 14.4 |
| | Ni | 0.21 | 0.14 | 0.15 | 0.18 | 0.1 | 0.12 | 0.15 | 0.13 | 0.12 | 0.1 | 0.1 | 0.38 |
| | Cr | 0.99 | 0.94 | 0.95 | 0.99 | 0.2 | 0.25 | 0.35 | 0.33 | 0.3 | 0.1 | 0.1 | 0.38 |
| | Ni + Cr | 1.2 | 1.08 | 1.1 | 1.17 | 0.3 | 0.37 | 0.50 | 0.46 | 0.42 | 0.20 | 0.20 | 0.76 |
| Added | CeO₂ [ppm] | 0 | 200 | 0 | 200 | 0 | 0 | 0 | 0 | 0 | 0 | 0 | 250 |
| element | SnO₂ [wt %] | 0 | 0 | 0 | 0 | 0.1 | 0.16 | 0.25 | 0.4 | 0.2 | 0 | 0 | 0 |
| Parameter | P_{Fe} | 2222 | 2808 | 735 | 897 | 346 | 175 | 343 | 247 | 377 | 519 | 690 | 671 |
| | P_{Ni} | 5.4 | 3.6 | 3.6 | 4.3 | 0.7 | 0.7 | 1.2 | 0.8 | 1.1 | 2.4 | 2.4 | 7.9 |
| | P_{cr} | 18.5 | 17.6 | 17.1 | 17.8 | 0.9 | 1.1 | 1.9 | 1.3 | 2.0 | 1.5 | 1.5 | 4.3 |
| | P_{Ni} + P_{Cr} | 23.9 | 21.2 | 20.7 | 22.1 | 1.6 | 1.8 | 3.1 | 2.1 | 3.0 | 3.9 | 3.9 | 12.2 |
| Optical | Ave. Internal T @ | — | — | — | — | — | — | — | — | — | 99.1 | 98.8 | 97.5 |
| properties | 430-450 nm [%] | | | | | | | | | | | | |
| @ 50 mm | Max Internal T [%] | — | — | — | — | — | — | — | — | — | 99.7 | 99.7 | 97.6 |
| (400-700 | Min Internal T [%] | — | — | — | — | — | — | — | — | — | 98.9 | 98.8 | 93.3 |
| nm) | ΔInternal T | — | — | — | — | — | — | — | — | — | 0.8 | 0.9 | 4.2 |
| | (Max-Min) [%] | | | | | | | | | | | | |
| Optical | X | — | — | — | — | — | — | — | — | — | 104.7 | 104.2 | 91.8 |
| properties | Y | — | — | — | — | — | — | — | — | — | 105.3 | 105.0 | 94.4 |
| @ 200 mm | Z | — | — | — | — | — | — | — | — | — | 103.2 | 102.4 | 86.8 |
| (400-700 | Spectrum | — | — | — | — | — | — | — | — | — | 0.980 | 0.976 | 0.919 |
| nm) | flatness A | | | | | | | | | | | | |
| Optical | Internal T @ | — | — | — | — | — | — | — | — | — | 92.4 | 80.6 | 60.5 |
| properties | 260 nm-1 mm | | | | | | | | | | | | |
| @ 1 mm | | | | | | | | | | | | | |
| Optical | External T @ 254 | — | — | — | — | — | — | — | — | — | 86.0 | 79.1 | 67.5 |
| properties | nm-0.5 mm | | | | | | | | | | | | |
| @ 0.5 mm | External T @ 365 | — | — | — | — | — | — | — | — | — | 91.3 | 91.3 | 90.9 |
| | nm-0.5 mm | | | | | | | | | | | | |
| Manu- | T2 [° C.] | (1542) | (1542) | (1590) | (1590) | (1748) | (1742) | (1757) | (1826) | (1777) | 1465 | 1465 | — |
| facturing | | | | | | | | | | | | | |
| properties | | | | | | | | | | | | | |

As seen from Tables 1 to 5, in the glasses of the cases 3 to 14, 16 to 46 and 49 to 65 where the composition ranges and parameters P_{Fe}, P_{Ni} and P_{Cr} are satisfied, a high value was obtained also for the internal transmittance at a wavelength of 430 to 450 nm, which is affected by absorption of Fe³⁺, Ni and Cr. The minimum value of the internal transmittance in the visible region was high and thus, high transparency was exhibited. The difference between the maximum value of the internal transmittance in the visible region and the minimum value of the internal transmittance in the visible region was small, and it was understood that the internal transmittance flatness is excellent.

In addition, the difference among the values of X, Y and Z calculated using isochromatic functions in the XYZ color system was small (the value of internal transmittance spectrum flatness A was large), and the glasses were found to be a glass with small color unevenness. Furthermore, it was seen that the ultraviolet internal transmittance can be low at the same time.

In the glasses of the cases 20 to 21, 36, 38 and 63 to 65, the ultraviolet external transmittance in the DUV region was also high, and they were found to be suitable for a device using ultraviolet light or deep ultraviolet light. In addition, T2 of the glass in the present invention was 1,850° C. or less, demonstrating that the melting performance is excellent.

On the other hand, in the glasses of the cases 1 and 2 where the content of total iron oxide exceeds 90 ppm by mass and the parameter P_{Fe} exceeds 3,000, the internal transmittance at a wavelength of 430 to 450 nm was low.

In the glass of the case 15 where although the content of total iron oxide is 90 ppm by mass or less, sodium is not contained and Na₂O/Al₂O₃ does not satisfy the range of more than 0.5, the bubble quality was insufficient, and despite a high internal transmittance at a wavelength of 430 to 450 nm, the difference between the maximum value of the internal transmittance in the visible region and the minimum value of the internal transmittance in the visible region was large.

In the glasses of the cases 47 and 48 where the total content of Ni and Cr exceeds 1.2 ppm by mass, the difference among the values of X, Y and Z calculated using isochromatic functions in the XYZ color system was large (the value of internal transmittance spectrum flatness A was small), and the glasses were a glass with large color unevenness.

The present invention is not limited to the above-described embodiments, etc. and various modifications or improvements can be made thereon within the scope of the gist of the present invention described in claims.

While the present invention has been described in detail and with reference to specific embodiments thereof, it will be apparent to one skilled in the art that various changes and modifications can be made therein without departing from the spirit and scope thereof. This application is based on Japanese Patent Application No. 2015-161102 filed on Aug. 18, 2015 and Japanese Patent Application No. 2016-074513 filed on Apr. 1, 2016, the entire subject matters of which are incorporated herein by reference.

### INDUSTRIAL APPLICABILITY

In the present invention, a glass having excellent melting performance, high transmittance and good internal transmittance flatness can be provided. The glass is assured of high luminance and less occurrence of in-plane luminance unevenness or color unevenness and can therefore be suitably used particularly as a light guide plate. In addition, since both low ultraviolet internal transmittance and excellent DUV resistance can be achieved, deterioration of a member due to ultraviolet radiation can be prevented, and the glass can be suitably used also as a glass for solar cell covers, whereas the glass having high ultraviolet external transmittance can be suitably utilized for a device using ultraviolet light or deep ultraviolet light. However, the usage is not limited thereto, and the glass can be suitably used for various applications.

1. A glass comprising from 5 to 90 ppm by mass of a total iron oxide (t-Fe₂O₃) in terms of Fe₂O₃, wherein
contents expressed in mass percentage on an oxide basis are SiO₂: from 50 to 85%, B₂O₃: from 0 to 10%, Na₂O: from 1 to 20%, and K₂O: 20% or less, and Sb₂O₃ is substantially not contained,
a total content (Ni+Cr) of Ni and Cr is more than 0 ppm by mass and 1.2 ppm by mass or less,
a ratio (Na₂O/Al₂O₃) of the content of Na₂O to the content of Al₂O₃, expressed in mass percentage on the oxide basis, is 0.5 or more and 50 or less,
a total content (A1203+K₂O) of Al₂O₃ and K₂O, expressed in mass percentage on the oxide basis, is 1% or more and 20% or less, and
the contents of each component satisfy the following formula (1):
P_{Fe}=[Fe³⁺]×(4.5×[MgO]+3.9×[CaO]+1.7×[SrO]+1.9×[BaO]+2.7×[Al₂O₃]−0.3×[Na₂O]−1.5×[K₂O]−1.7×[Li₂O])≤3000 (1)
wherein [Fe³⁺] represents a content expressed in ppm by mass and the others represent the contents expressed in mass percentage on the oxide basis.

2. The glass according to claim 1, wherein the content of Ni is more than 0 ppm by mass and 0.8 ppm by mass or less.

3. The glass according to claim 1, wherein the content of Cr is 1.0 ppm by mass or less.

4. The glass according to claim 1, wherein the content of CeO₂ on the oxide basis is 500 ppm by mass or less.

5. The glass according to claim 1, wherein the content of Al₂O₃, expressed in mass percentage on the oxide basis, is more than 0% and 14% or less.

6. The glass according to claim 1, wherein the content of SnO₂, expressed in mass percentage on the oxide basis, is more than 0% and 1% or less.

7. The glass according to claim 6, wherein the content of Al₂O₃, expressed in mass percentage on the oxide basis, is from 10 to 14%.

8. The glass according to claim 1, comprising from 10 to 65 ppm by mass of the total iron oxide (t-Fe₂O₃) in terms of Fe₂O₃.

9. The glass according to claim 1, wherein the contents of each component satisfy the following formula (2):
P_{Ni}=[Ni]×(2.2×[MgO]+1.9×[CaO]+1.1×[SrO]+1.1×[BaO])≤21 (2)
wherein [Ni] represents the content expressed in ppm by mass and the others represent the contents expressed in mass percentage on the oxide basis.

10. The glass according to claim 1, wherein the contents of each component satisfy the following formula (3):
P_{Cr}=[Cr]×(1.9×[MgO]+1.3×[CaO]+0.6×[SrO]+0.5×[BaO])≤21 (3)
wherein [Cr] represents the content expressed in ppm by mass and the others represent the contents expressed in mass percentage on the oxide basis.

11. The glass according to claim 10, wherein a total (P_{Ni}+P_{Cr}) of P_{Ni} represented by the following formula (2) and the P_{Cr} represented by the formula (3) is 25 or less:
P_{Ni}=[Ni]×(2.2×[MgO]+1.9×[CaO]+1.1×[SrO]+1.1×[BaO])≤21 (2)
wherein [Ni] represents the content expressed in ppm by mass and the others represent the contents expressed in mass percentage on the oxide basis.

12. The glass according to claim 1, wherein an average value of internal transmittance (α) at a wavelength of 430 to 450 nm at an optical path length of 50 mm is 95.5% or more.

13. The glass according to claim 1, wherein an amount of divalent iron (Fe²⁺) in terms of Fe₂O₃ is more than 0 ppm by mass and 15 ppm by mass or less.

14. The glass according to claim 1, wherein contents of alkaline earth metal oxides, expressed in mass percentage, satisfy the relationship of {(CaO+SrO+BaO)−MgO}≥−8.

15. The glass according to claim 1, wherein a minimum value of internal transmittance (β) at a wavelength of 400 to 700 nm at an optical path length of 50 mm is 94.5% or more and a difference between a maximum value of the internal transmittance (β) and the minimum value of the internal transmittance (β) is 5% or less.

16. The glass according to claim 1, wherein a value of internal transmittance spectrum flatness A of the glass at a wavelength of 400 to 700 nm, determined according to the following formula (4), is 0.95 or more:
A=min(X,Y,Z)/max(X,Y,Z) (4)
wherein X, Y and Z are values represented respectively by X=Σ(S(λ)×x(λ)), Y=Σ(S(λ)×y(λ)) and Z=Σ(S(λ)×z(λ)) using isochromatic functions x(λ), y(λ) and z(λ) in an XYZ color system based on MS Z8701: 1999 and internal transmittance S(λ) at a wavelength of 400 to 700 nm at an optical path length of 200 mm, and the min(X,Y,Z) represents the minimum value out of X, Y and Z and the max(X,Y,Z) represent the maximum value out of X, Y and Z.

17. A glass sheet comprising the glass according to claim 1, wherein the glass sheet has a length of at least one side of 140 mm or more and a thickness of 0.5 mm or more

18. A light guide plate comprising the glass according to claim 1.
